(19) United States
(12) Patent Application Publication
(10) Pub. No.: US 2007/0218390 A1
(43) Pub. Date: Sep. 20, 2007

(54) TONER FOR DEVELOPING ELECTROSTATIC IMAGES, PRODUCTION METHOD THEREOF; DEVELOPER, IMAGE FORMING METHOD, IMAGE FORMING APPARATUS, AND PROCESS CARTRIDGE

(76) Inventors: Tsuyoshi Nozaki, Ikeda-shi (JP); Chiyoshi Nozaki, Otsu-shi (JP); Atsushi Yamamoto, Kawanishi-shi (JP); Mitsuyo Matsumoto, Ibaraki-shi (JP); Minoru Nakamura, Takarazuka-shi (JP); Katsunori Kurose, Takarazuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/685,890

(22) Filed: Mar. 14, 2007

(30) Foreign Application Priority Data
Mar. 15, 2006 (JP) 2006-070543
Mar. 17, 2006 (JP) 2006-075650
Mar. 16, 2006 (JP) 2006-073399

(51) Int. Cl. G03G 9/087

(52) U.S. Cl. 430/109.3; 430/137.15; 430/110.1; 430/109.4; 430/123.5; 430/110.2

(57) ABSTRACT

The present invention provides a toner which is obtained by dissolving and/or dispersing in an organic solvent a toner material that includes at least a functional group-containing modified polyester resin capable of undergoing an elongation reaction and/or a crosslinking reaction with an active hydrogen group-containing compound, a vinyl resin, a releasing agent, and a colorant to prepare a toner solution, then emulsifying and/or dispersing the toner solution in an aqueous medium to prepare an emulsified dispersion, and allowing the functional group-containing modified polyester resin to undergo an elongation reaction and/or a crosslinking reaction with the active hydrogen group-containing compound in the aqueous medium, wherein the vinyl resin is concentrated near the surface of the toner.

### BACKGROUND OF THE INVENTION

1. Field of the Invention

The present invention relates to a toner for developing electrostatic images by which a latent electrostatic image is developed to form a visible image in electrophotographic method, electrostatic recording method, electrostatic printing method, etc., and production method thereof; and to a developer, an image forming method, an image forming apparatus, and a process cartridge.

2. Description of the Related Art

When a toner is fixed, contact heat fixing methods such as a heat roller fixing method have been widely employed. A fixing device used for the heat roller fixing method comprises a heating member (e.g. heating roller) and a pressure member (e.g. pressure roller). A toner image formed on a recording sheet is melted and fixed by passing through a pressure contact part (nip) formed between the heating roller and the pressure roller.

In contact heat fixing methods, typified by the heat roller fixing method, the surface of a heating roller in a fixing device is contacted with the toner image on a recording sheet. Thus, a portion of the toner image is adhered to the heating roller, which is transferred to the following recording sheet, leading to the pollution of the recording sheet. This so-called offset phenomenon is required to be prevented in the contact heat fixing methods.

In order to prevent occurrence of such offset phenomenon, a technique is known in which a fixing oil such as a silicon oil is applied or penetrated to the heating roller and pressure roller of a fixing device. However, in order to downsize the fixing device and lower the operation costs, oilless fixing devices without a fixing oil is applying system, or fixing devices applying less amount of fixing oil are employed. For these fixing devices, toners including a releasing agent serving as an offset inhibitor are used.

In the case of heat fixing methods, the heating temperature is preferably as low as possible from the viewpoint of energy saving. In attempting to achieve this, a toner is designed such that a binder resin, which makes up the toner, has low thermal properties. However, too low thermal properties impair anti-heat preservability, causing problems such as blocking. In order to achieve both of these, it is advantageous to use polyester resins as a binder resin. Since polyester resins have a relatively low viscosity and a high elasticity compared to vinyl copolymer resins, they have excellent fixing property at low temperatures and favorable anti-heat preservability.

When a toner including a releasing agent sufficient for preventing offset is produced by a conventional pulverization method, a major portion of releasing agent is exposed to the surface of the resultant toner causing problems such as filming and blocking. On the other hand, polymerization methods are known that include: suspension-polymerization method in which reactive monomers are polymerized in an aqueous medium; and emulsion-aggregation method in which fine particles are prepared by emulsion polymerization previously and are aggregated. Toners produced by these polymerization methods can include a releasing agent more than those produced by a pulverization method. For the suspension polymerization method, Japanese Patent (JP-B) No. 3195362 discloses a method for producing a toner of which structure is controlled, including forming particles in a usual way, followed by adding monomers to polymerize.

For the emulsion aggregation method, Japanese Patent Application Laid-Open (JP-A) No. 2002-116574 discloses a toner of which structure is controlled. The toner is prepared by forming particles due to aggregation in a usual way, followed by adding emulsion polymerization particles to aggregate.

In these suspension-polymerization method and emulsion-aggregation method, however, vinyl copolymer resins are typically used because polymerization is performed in an aqueous medium. It is difficult to use polyester resins that are prepared by polymerization at a high temperature of about 200° C.

In addition, methods for producing a toner are proposed that include finely dispersing polyester resins and vinyl resins in an aqueous medium to prepare fine particles and aggregating the fine particles to prepare a toner in which species of resins are mixed or a toner which has a controlled structure composed of such species of resins. (See, for example, JP-A Nos. 2004-295105, 2005-084183, 2005-077603, 2005-077602, and 2004-354706). These so-called aggregation methods, however, has a drawback. Metal salts for aggregation, surfactants for dispersion, or the like are likely to be incorporated inside the toner; thus the toner is like to include moisture or the like, resulting in the deterioration of environmental resistance. In the method in which vinyl resin fine particles are aggregated on the surface of a core particle made of e.g. polyester resin, it is difficult to coat the core particle uniformly with a small amount of vinyl resin except the case where the compatibility of both particles is extremely good. In addition, it takes long time to coat the core particle with a large amount of vinyl resin, resulting in the deterioration of productivity.

As a method for manufacturing a toner using a polyester resin, a so-called solution suspension method is known in which a resin polymerized previously is dissolved in an organic solvent, and particles are formed in an aqueous medium. In this method, the molecular mass of the toner equals that of the resins placed in the vessel. In order to adjust the heat characteristic of the toner, a low-molecular-mass resin and a high-molecular-mass resin are typically used in combination; however, the high-molecular-mass resin cannot be used in large amount. This is because when a high-molecular-mass resin is dissolved in a solvent, the viscosity of the resulting solution is too high so that the solution has poor ability to form particles. Thus, the molecular mass of the low-molecular-mass resin has to be set to be relatively high, which is disadvantageous for fixing at low temperatures.

In order to solve such problem, a method for producing a toner using a modified polyester resin with a reactive group, instead of using high-molecular-mass resins, is proposed. In the method, the modified polyester resin with a reactive group is elongated and/or cross-linked after granulation to thereby adjust the molecular mass. Use of this method enables the adjustment of the heat characteristic of toner, but the toner structure cannot be sufficiently controlled and thereby colorants and releasing agents tend to be exposed on the surface, which may cause problems.

As described above, in the present situation, a toner which achieves both of fixing property at low temperatures and anti-heat preservability, excels in off-set resistance, has a controlled structure, does not contaminate a developing device or the like, has good chargeability, and excels in environmental resistance; and related techniques have not been provided yet.

### BRIEF SUMMARY OF THE INVENTION

An object of the present invention is to provide a toner for developing electrostatic images which achieves both of fixing property at low temperatures and anti-heat preservability, excels in off-set resistance, has a controlled structure, does not contaminate a developing device or the like, has good chargeability, and excels in environmental resistance, and production method thereof; and to provide a developer, an image forming method, an image forming apparatus, and a process cartridge.

Means for solving the above-mentioned problems are as follows. Specifically,

<1> A toner, which is obtained by: at least one of dissolving and dispersing at least a polyester resin, a vinyl resin, a releasing agent, and a colorant in an organic solvent, wherein the polyester resin includes a functional group-containing modified polyester resin capable of undergoing at least one of an elongation reaction and a crosslinking reaction with an active hydrogen group-containing compound; then at least one of emulsifying and dispersing at least one of the dissolved solution and the dispersed solution in an aqueous medium to prepare an emulsified dispersion; and allowing the functional group-containing modified polyester resin to undergo at least one of an elongation reaction and a crosslinking reaction with the active hydrogen group-containing compound in the aqueous medium, wherein the vinyl resin is concentrated near the surface of the toner.

<2> The toner according to the <1>, wherein an acid value of the vinyl resin is from 20 mgKOH/g to 250 mgKOH/g.

<3> The toner according to the <2>, wherein the acid value of the vinyl resin is from 50 mgKOH/g to 250 mgKOH/g.

<4> The toner according to the <1>, wherein the vinyl resin includes a resin having in a side chain thereof a functional group selected from —OH, —COOH, —CONR¹R², and —NHCONR³R⁴ where R¹, R², R³, and R⁴ independently represent a hydrocarbon group having a carbon number of 1 to 8.

<5> The toner according to the <1>, wherein the vinyl resin includes a resin having a silanol group.

<6> The toner according to the <5>, wherein the silanol group is obtained by subjecting a functional group expressed by the following general formula to chemical treatment: 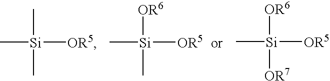
where, in the general formula, R⁵, R⁶, and R⁷ independently represent any one of a branched or straight-chain alkyl group having a carbon number of 1 to 6, an alicyclic group having a carbon number of 3 to 6, and a substituted or unsubstituted phenyl group.

<7> The toner according to the <1>, wherein a content of the vinyl resin is 10% by mass to 50% by mass of total resin components.

<8> The toner according to the <1>, wherein the vinyl resin has a mass average molecular mass of from 3,000 to 50,000.

<9> The toner according to the <1>, wherein the vinyl resin has a glass transition temperature of from 40° C. to 80° C.

<10> The toner according to the <1>, wherein the functional group-containing modified polyester resin is a modified polyester resin having an isocyanate group at an end thereof.

<11> The toner according to the <1>, wherein the toner includes a modified polyester resin having at least one of a urethane group and a urea group.

<12> The toner according to the <1>, wherein the toner includes a charge controlling agent.

<13> The toner according to the <1>, wherein the aqueous medium includes resin fine particles.

<14> The toner according to the <1>, wherein a ratio, RI=I1/I2, of peak absorbance around 700 cm⁻¹, I1, to peak absorbance around 730 cm⁻¹, I2, in an infrared absorption spectrum of the toner measured by FT-IR method, and a ratio, RA=A1/A2, of peak absorbance around 700 cm⁻¹, A1, to peak absorbance around 730 cm⁻¹, A2, in an infrared absorption spectrum of the toner measured by FT-ATR-IR method, satisfy: RI<RA.

<15> A method for producing a toner including: at least one of dissolving and dispersing at least a polyester resin, a vinyl resin, a releasing agent, and a colorant in an organic solvent, wherein the polyester resin includes a functional group-containing modified polyester resin capable of undergoing at least one of an elongation reaction and a crosslinking reaction with an active hydrogen group-containing compound; and then at least one of emulsifying and dispersing at least one of the dissolved solution and the dispersed solution in an aqueous medium, wherein a content of the vinyl resin is 10% by mass to 50% by mass of total resin components.

<16> A developer including a toner, wherein the toner is obtained by: at least one of dissolving and dispersing at least a polyester resin, a vinyl resin, a releasing agent, and a colorant in an organic solvent, wherein the polyester resin includes a functional group-containing modified polyester resin capable of undergoing at least one of an elongation reaction and a crosslinking reaction with an active hydrogen group-containing compound; then at least one of emulsifying and dispersing at least one of the dissolved solution and the dispersed solution in an aqueous medium to prepare an emulsified dispersion; and allowing the functional group-containing modified polyester resin to undergo at least one of an elongation reaction and a crosslinking reaction with the active hydrogen group-containing compound in the aqueous medium, wherein the vinyl resin is concentrated near the surface of the toner.

<17> A process cartridge including a latent electrostatic image bearing member, and a developing unit configured to develop a latent electrostatic image on the latent electrostatic image bearing member using a toner to form a visible image, wherein the process cartridge is detachable to a main body of a image forming apparatus, wherein the toner is obtained by: at least one of dissolving and dispersing at least a polyester resin, a vinyl resin, a releasing agent, and a colorant in an organic solvent, wherein the polyester resin comprises a functional group-containing modified polyester resin capable of undergoing at least one of an elongation reaction and a crosslinking reaction with an active hydrogen group-containing compound; then at least one of emulsifying and dispersing at least one of the dissolved solution and the dispersed solution in an aqueous medium to prepare an emulsified dispersion; and allowing the functional group-containing modified polyester resin to undergo at least one of an elongation reaction and a crosslinking reaction with the active hydrogen group-containing compound in the aqueous medium, wherein the vinyl resin is concentrated near the surface of the toner.

<18> An image forming method including forming a latent electrostatic image on a latent electrostatic image bearing member, developing the latent electrostatic image using a toner to form a visible image, transferring the visible image to a recording medium, and fixing the image transferred to the recording medium, wherein the toner is obtained by: at least one of dissolving and dispersing at least a polyester resin, a vinyl resin, a releasing agent, and a colorant in an organic solvent, wherein the polyester resin includes a functional group-containing modified polyester resin capable of undergoing at least one of an elongation reaction and a crosslinking reaction with an active hydrogen group-containing compound; then at least one of emulsifying and dispersing at least one of the dissolved solution and the dispersed solution in an aqueous medium to prepare an emulsified dispersion; and allowing the functional group-containing modified polyester resin to undergo at least one of an elongation reaction and a crosslinking reaction with the active hydrogen group-containing compound in the aqueous medium, wherein the vinyl resin is concentrated near the surface of the toner.

<19> An image forming apparatus including a latent electrostatic image bearing member, a latent electrostatic image forming unit configured to form a latent electrostatic image on the latent electrostatic image bearing member, a developing unit configured to develop the latent electrostatic image using a toner to form a visible image, a transferring unit configured to transfer the visible image to a recording medium, and a fixing unit configured to fix the image transferred to the recording medium, wherein the toner is obtained by: at least one of dissolving and dispersing at least an active hydrogen group-containing compound, a polyester resin, a vinyl resin, a releasing agent, and a colorant in an organic solvent, wherein the polyester resin includes a functional group-containing modified polyester resin capable of undergoing at least one of an elongation reaction and a crosslinking reaction with the active hydrogen group-containing compound; then at least one of emulsifying and dispersing at least one of the dissolved solution and the dispersed solution in an aqueous medium to prepare an emulsified dispersion; and allowing the functional group-containing modified polyester resin to undergo at least one of an elongation reaction and a crosslinking reaction with the active hydrogen group-containing compound in the aqueous medium, wherein the vinyl resin is concentrated near the surface of the toner.

### BRIEF DESCRIPTION OF THE SEVERAL VIEWS OF THE DRAWINGS

FIG. 1 is a schematic view showing an example of the process cartridge of the present invention.

FIG. 2 is a schematic view showing an example of the fixing device used for the evaluation of fixability of the toner of the present invention.

FIG. 3 is a view illustrating an example of the structure of the toner of the present invention.

FIG. 4 explains a method for calculating a glass transition temperature from DSC line and DDSC line.

FIG. 5 is a schematic view showing an example of the developing unit used in the present invention.

FIG. 6 is a schematic view showing an example of the image forming apparatus of the present invention.

### DETAILED DESCRIPTION OF THE INVENTION

(Toner)

The toner of the present invention is obtained by dissolving and/or dispersing at least an active hydrogen group-containing compound, a polyester resin, a vinyl resin, a releasing agent, and a colorant in an organic solvent, wherein the polyester resin comprises a functional group-containing modified polyester resin capable of undergoing at least one of an elongation reaction and a crosslinking reaction with the active hydrogen group-containing compound; then emulsifying and/or dispersing the dissolved solution and/or dispersed solution in an aqueous medium to prepare an emulsified dispersion; and allowing the functional group-containing modified polyester resin to undergo an elongation reaction and/or a crosslinking reaction with the active hydrogen group-containing compound in the aqueous medium.

In the toner, the vinyl resin is concentrated near the surface of the toner.

The term “near the surface of the toner” means a region within 0.5 μm from the toner surface, and the toner comprises a layer, which contains the vinyl resin, in the region. The vinyl resin-containing layer may be present continuously across the entire of the region near the surface of the toner or may be distributed across the entire of the region, but the vinyl resin-containing layer is preferably present over the entire of the region near the surface of the toner.

The presence of vinyl resin being concentrated near the surface of the toner can be detected as follows. Most of the resin for use in the toner exhibits a characteristic absorption in an infrared absorption spectrum. Vinyl resins exhibit an absorption different from polyester resins, and especially, vinyl resins having a monosubstituted aromatic ring such as styrene have a strong absorption near 700 cm⁻¹. On the other hand, absorption derived from polyester appears near 730 cm⁻¹. These absorptions enable identification of reins that are contained, and change in the ratio of resins contained results in the change of intensity. In a FT-ATR-IR measurement, in principle, absorption intensity is affected more by the substances present closer to the surface of the sample to be measured. That is, when the infrared absorption spectrum near the surface of the toner is measured, a characteristic absorption intensity changes depending on the type of resin near the surface of the toner and the distribution thereof. Thus, combination of results of measurements by the typical FT-IR method and FT-ATR-IR method reveals the distribution of the resin near the surface of the toner. Specifically, when comparing the ratio of the peak intensity around 700 cm⁻¹ and the peak intensity around 730 cm⁻¹ of FT-IR method with that of FT-ATR-IR method, the presence of vinyl resin being concentrated near the surface of the toner, as in the present invention, makes the ratio of the FT-ATR-IR method larger than that of the FT-IR method. For the vinyl resin, use of monomer having an aromatic ring such as styrene is preferable because π electrons are increased, resulting in favorable charge ability of the toner; however, the ratio of monomer is determined considering the adjustment of properties of the entire vinyl resin such as a glass transition temperature and acid value.

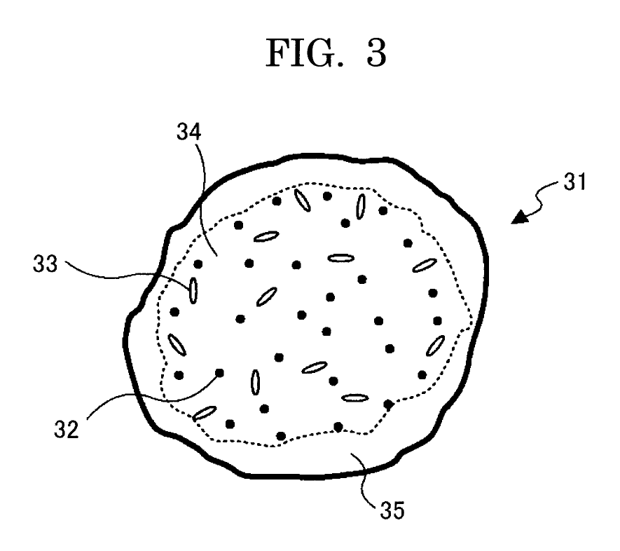

FIG. 3 schematically illustrates a structure of the toner of the present invention. As shown in FIG. 3, a toner 31 of the present invention has a structure composed of a core part 34 and a pseudo-shell part 35 near the surface of the core part 34. The core part 34 comprises at least a colorant 32, releasing agent 33 and binder resin having a polyester skeleton, and the shell part 35 is made of vinyl resin. That is, the core part as a main component of the toner comprises polyester resin advantageous for achieving both of fixing property at low temperatures and anti-heat preservability, and the pseudo-shell part, a surface part of the toner which significantly affects the charge ability of the toner, comprises vinyl lo resin advantageous for the prevention of the exposure of wax and colorant to the surface and for the improvement of charge ability.

The reason why the vinyl resin is advantageous for the prevention of the exposure of wax and colorant to the surface is that, for example, (1) the vinyl resin is likely to move towards O/W interface due to its high polarity and forms a pseudo shell, thereby covering the wax and colorant, and (2) functional groups that allow the toner to become electrically negative, such as a carboxylic group and sulfonic group derived from a vinyl resin, can be present on the surface of the particle.

Thus, a toner, which has good fixing properties such as fixing property at low temperatures, and has good developability and transferability that are influenced by charge ability.

<Vinyl Resin>

The vinyl resin is not particularly limited and may be selected accordingly. Several different vinyl resins may be used in combination. Vinyl resins that are sufficiently dissolved or swelled in an organic solvent are preferable. When the vinyl resin is not dissolved or swelled in the organic solvent used during granulation, the vinyl resin may not be incorporated into particles to be formed sufficiently, or the particles to be formed may have wide distribution of particle diameter. In addition, the vinyl resin may not be concentrated near the surface of the manufactured toner.

The vinyl resin is a polymer in which any vinyl group-containing monomer is mono- or co-polymerized. For example, vinyl resins having in a side chain a functional group selected from —OH, —COOH, —CONR¹R², and —NHCONR³R⁴ (where R¹, R², R³, and R⁴ independently represent a hydrocarbon group having a carbon number of 1 to 8) are suitable. The vinyl group-containing monomer includes the following (1) to (12).

(1) Vinyl Hydrocarbon

Examples of the vinyl hydrocarbon include aliphatic vinyl hydrocarbons, alicyclic vinyl hydrocarbons, aromatic vinyl hydrocarbons, and the like.

Examples of the aliphatic vinyl hydrocarbon include alkenes (e.g. ethylene, propylene, butene, isobutylene, pentene, heptene, diisobutylene, octene, dodecene, octadecene, α-olefin except those mentioned above, and the like), alkadienes (e.g. butadiene, isoprene, 1,4-pentadiene, 1,6-hexadiene and 1,7-octadiene), and the like.

Examples of the alicyclic vinyl hydrocarbon include mono- or di-cycloalkene and alkadienes, (e.g. cyclohexene, (di)cyclopentadiene, vinylcyclohexene and ethylidene bicycloheptene); terpenes, (e.g., pinene, limonene, and indene); and the like.

Examples of the aromatic vinyl hydrocarbon include styrene or hydrocarbyl (alkyl, cycloalkyl, aralkyl and/or alkenyl) substitution products of styrene (e.g. α-methylstyrene, vinyltoluene, 2,4-dimethylstyrene, ethylstyrene, isopropylstyrene, butylstyrene, phenylstyrene, cyclohexylstyrene, benzylstyrene, crotylbenzene, divinylbenzene, divinyltoluene, divinylxylene and trivinylbenzene); vinylnaphthalene; and the like.

(2) Carboxyl Group-Containing Vinyl Monomers or Salts Thereof

Carboxyl group-containing vinyl monomers or salts thereof include, for example, unsaturated monocarboxylic acids and unsaturated dicarboxylic acids having a carbon number of 3 to 30, anhydrides of these carboxylic acids and monoalkyl esters (having a carbon number of 1 to 24) of these carboxylic acids. Specific examples thereof include (meth)acrylic acid, maleic acid (anhydride), monoalkyl maleate, fumaric acid, monoalkyl fumarate, crotonic acid, itaconic acid, monoalkyl itaconate, itaconic glycol monoether, citraconic acid, monoalkyl citraconate, cinnamic acid, and the like.

(3) Sulfonic Group-Containing Vinyl Monomers, Vinyl Monoesters of Sulfuric Acid or Salts of These:

Alkene sulfonic acids having a carbon number of 2 to 14 such as vinyl sulfonic acid, (meth)allyl sulfonic acid, methyl vinyl sulfonic acid, and styrene sulfonic acid; alkyl derivatives of these compounds having a carbon number of 2 to 24 such as α-methylstyrene sulfonic acid; sulfo(hydroxy)alkyl-(meth)acrylates or -(meth)acrylamides such as sulfopropyl(meth)acrylate, 2-hydroxy-3-(meth)acryloxypropyl suifonic acid, 2-(meth)acryloylamino-2,2-dimethylethane sulfonic acid, 2-(meth)acryloyloxyethane sulfonic acid, 3-(meth)acryloyloxy-2-hydroxypropane sulfonic acid, 2-(meth)acrylamide-2-methylpropane sulfonic acid, 3-(meth)acrylamide-2-hydroxypropane sulfonic acid, alkyl(having a carbon number of 3 to 18)allylsulfo succinic acid, sulfic acid esters of poly(n=2 to 30)oxyalkylene(ethylene, propylene, butylene and their mono, random and block copolymers) mono(meth)acrylate [e.g. sulfic acid esters of poly(n=5 to 15)oxypropylene monomethacrylate]; sulfic acid esters of polyoxyethylene polycyclic phenyl ether

(4) Phosphate Group-Containing Vinyl Monomers or Salts Thereof

Examples of the phosphate group-containing vinyl monomer include (meth)acryloyloxyalkyl phosphoric acid monoesters, (meth)acryloyloxyalkyl (having a carbon number of 1 to 24) phosphonic acids, salts of these, and the like.

Examples of the (meth)acryloyloxyalkyl phosphoric acid monoester include 2-hydroxyethyl(meth)acryloyl phosphate, phenyl-2-acryloyloxyethyl phosphate, and the like.

Examples of the (meth)acryloyloxyalkyl (having a carbon number of 1 to 24) phosphonic acids include 2-acryloyloxyethyl phosphonic acid, and the like.

Examples of the salts of vinyl monomers mentioned in above (2) to (4) include alkali metal salts (such as sodium salts, potassium salts), alkaline-earth metal salts (such as calcium salts, magnesium salts), ammonium salts, amine salts, quaternary ammonium salts, and the like.

(5) Hydroxyl Group-Containing Vinyl Monomers

Examples of the hydroxyl group-containing vinyl monomer include hydroxystyrene, N-methylol(meth)acrylamide, hydroxyethyl(meth) acrylate, hydroxypropyl(meth) acrylate, polyethyleneglycol mono(meth)acrylate, (meth)allylalcohol, crotyl alcohol, isocrotyl alcohol, 1-butene-3-ol, 2-butene-1-ol, 2-butene-1,4-diol, propargyl alcohol, 2-hydroxyethyl propenyl ether, sucrose allyl ether, and the like.

(6) Nitrogen-Containing Vinyl Monomers

Examples of the nitrogen-containing vinyl monomer include amino group-containing vinyl monomers, amide group-containing vinyl monomers, nitrile group-containing vinyl monomers, quaternary ammonium cation group-containing vinyl monomers, nitro group-containing vinyl monomers, and the like.

Examples of the amino group-containing vinyl monomer include aminoethyl(meth)acrylate, dimethylaminoethyl(meth)acrylate, diethylaminoethyl(meth)acrylate, t-butylaminoethyl(meth)acrylate, N-aminoethyl(meth)acrylamide, (meth)acrylamine, morpholinoethyl(meth)acrylate, 4-vinylpyridine, 2-vinylpyridine, crotylamine, N,N-dimethylaminostyrene, methyl-α-acetoamino acrylate, vinylimidazole, N-vinylpyrrol, N-vinylthiopyrrolidone, N-arylphenylenediamine, aminocarbazole, aminothiazole, aminoindole, aminopyrrol, aminoimidazole, aminomercaptothiazole, salts of these, and the like.

Examples of the amide group-containing vinyl monomer include (meth)acrylamide, N-methyl(meth)acrylamide, N-butylacrylamide, diacetoneacrylamide, N-methylol(meth)acrylamide, N,N-methylene-bis(meth)acrylamide, cinammic acid amide, N,N-dimethylacrylamide, N,N-dibenzylacrylamide, methacrylformamide, N-methyl-N-vinylacetamide, N-vinylpyrrolidone, and the like.

Examples of the nitrile group-containing vinyl monomer include (meth)acrylonitrile, cyanostyrene, cyanoacrylate, and the like.

Examples of the quaternary ammonium cation group-containing vinyl monomer include quaternized tertiary amine group-containing vinyl monomers (quaternized compounds with use of quaternizing agent such as methyl chloride, dimethyl sulfonic acid, benzyl chloride, and dimethyl carbonate) such as dimethylaminoethyl(meth)acrylate, diethylaminoethyl(meth) acrylate, dimethylaminoethyl(meth) acrylamide, diethylaminoethyl(meth)acrylamide, and diallylamine; and the like.

Examples of the nitro group-containing vinyl monomer include nitrostyrene, and the like.

(7) Epoxy Group-Containing Vinyl Monomer

Examples of the epoxy group-containing vinyl monomer include glycidyl(meth) acrylate, tetrahydrofurfuryl(meth) acrylate, p-vinylphenylphenyloxide, and the like.

(8) Vinylesters, Vinyl (Thio)ethers, Vinyl Ketones, or Vinyl Sulfones:

Examples of the vinylester include vinyl acetate, vinyl butyrate, vinyl propionate, diallyl phthalate, diallyl adipate, isopropenyl acetate, vinyl methacrylate, methyl-4-vinyl benzoate, cyclohexyl methacrylate, benzyl methacrylate, phenyl(meth)acrylate, vinylmethoxy acetate, vinyl benzoate, ethyl-α-ethoxyacrylate, alkyl(meth)acrylates including alkyl group having a carbon number of 1 to 50 (such as methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate and eicosyl(meth)acrylate), dialkyl fumarates (two alkyl groups have a carbon number of 2 to 8 and have straight-chain, branched-chain or alicyclic structure), dialkyl maleates (two alkyl groups have a carbon number of 2 to 8 and have straight-chain, branched-chain or alicyclic structure), poly(meth)allyloxyalkanes (such as diallyloxyethane, triallyloxyethane, tetraallyloxyethane, tetraallyloxypropane, tetraallyloxybutane and tetramethallyloxyethane), vinyl monomers having polyalkyleneglycol chain (such as polyethyleneglycol (molecular mass of 300) mono(meth)acrylate, polypropyleneglycol (molecular weight of 500) monoacrylate, adduct of (meth)acrylate with 10 mols of methyl alcohol ethyleneoxide, and adduct of (meth)acrylate with 30 mols of lauryl alcohol ethyleneoxide), poly(meth)acrylates (poly(meth)acrylates of polyalcohols such as ethyleneglycol di(meth) acrylate, propylene glycol di(meth)acrylate, neopentylglycol di(meth)acrylate, trimethylolpropane tri(meth)acrylate, and polyethyleneglycol di(meth)acrylate), and the like.

Examples of the vinyl (thio)ether include vinyl methyl ether, vinyl ethyl ether, vinyl propyl ether, vinyl butyl ether, vinyl-2-ethylhexyl ether, vinyl phenyl ether, vinyl-2-methoxyethyl ether, methoxybutadiene, vinyl-2-butoxyethyl ether, 3,4-dihydro-1,2-pyran, 2-butoxy-2′-vinyloxydiethyl ether, vinyl-2-ethylmercaptoethyl ether, acetoxystyrene, phenoxystyrene, and the like.

Examples of the vinyl ketone include vinyl methyl ketone, vinyl ethyl ketone, vinyl phenyl ketone, and the like.

Examples of the vinyl sulfone include divinyl sulfide, p-vinyl diphenyl sulfide, vinyl ethyl sulfide, vinyl ethyl sulfone, divinyl sulfone, and divinyl sulfoxide, and the like.

(9) Fluorine Atom-Containing Vinyl Monomer

Examples of the fluorine atom-containing vinyl monomer include 4-fluorostyrene, 2,3,5, 6-tetrafluorostyrene, pentafluorophenyl(meth)acrylate, pentafluorobenzyl(meth)acrylate, perfluorohexyl(meth)acrylate, perfluorocyclohexylmethyl(meth) acrylate, 2,2,2-trifluoroethyl(meth)acrylate, 2,2,3,3-tetrafluoropropyl(meth)acrylate, 1H, 1H, 4H-hexafluorobutyl(meth)acrylate, 1H, 1H, 5H-octafluoropentyl(meta)acrylate, 1H, 1H, 7H-dodecafluoroheptyl(meth)acrylate, perfluorooctyl(meth) acrylate, 2-perfluorooctylethyl(meth) acrylate, heptadecafuluorodecyl(meth)acrylate, trihydroperfluoroundecyl(meth)acrylate, perfluoronorbornylmethyl(meth)acrylate, 1H-perfluoroisobornyl(meth)acrylate, 2-(N-butylperfluorooctanesulfoneamide)ethyl(meth)acrylate, 2-(N-ethylperfluorooctanesulfoneamide)ethyl(meth)acrylate, corresponding derivatives of a-fluoroacrylic acid: bis-hexafluoroisopropyl itaconate, bis-hexafluoroisopropyl maleate, bis-perfluorooctyl itaconate, bis-perfluorooctyl maleate, bis-trifluoroethyl itaconate, bis-trifluoroethyl maleate; vinyl heptafluorobutyrate, vinyl perfluoroheptanoate, vinyl perfluorononanoate, vinyl perfluorooctanoate; and the like.

(10) Vinyl Monomer Including a Functional Group Selected From OH, —COOH, —CONR¹R² and —NHCONR³R⁴

The monomer including a functional group selected from —OH, —COOH, —CONR¹R², and —NHCONR³R⁴ (where R¹, R², R³, and R⁴ independently represent a hydrocarbon group having a carbon number of 1 to 8) includes vinyl group-containing monomers that comprise a straight-chain alkyl group of 2 to 22 carbon numbers having the functional group. Examples thereof include 2-hydroxyethyl acrylate, 2-hydroxyethyl methacrylate, 12-hydroxydodecyl acrylate, 6-(p-carboxyphenoxy)hexyl methacrylate, acryloyloxy (3-carboxypropane), 17-allyloxy stearic acid amide, 18-(vinylphenoxy)stearylurea, 21-allyloxybehenic (N-methyl)amide, and the like.

(11) Vinyl Monomer Including a Silanol Group

Examples of the vinyl monomer including a silanol group include vinyltrimethoxysilane vinyltriethoxysilane, vinyltriacetoxysilane, p-styryltrimethoxysilane, 3-methacryloyloxypropylmethyldiethoxysilane, 3-methacryloyloxypropyltrimethoxysilane, 3-methacryloyloxypropylmethyldiethoxysilane, 3 -methacryloyloxypropyltriethoxysilane, 3 -acryloyloxyp ropyltrimethoxysilane, 3 -methacryloyloxypropylmethyldip ropoxysilane, 3 -methacryloyloxypropylmethyldiisopropoxysilane, 3 -methacryloyloxypropyldimethylcyclohexyloxysilane, p-styryldimethylphenoxysilane, p-styryltribenzyloxysilane, and the like.

It is preferable that the particles that comprise a vinyl resin having at least a silanol group are used in such a condition that they are dispersed in an aqueous medium. Such particles that comprise a vinyl resin can be produced by common emulsion polymerization or the like.

Typically, the silanol group can be obtained by subjecting an alkoxysilyl group to chemical treatment, and those obtained by subjecting the functional group expressed by the following general formula to chemical treatment are preferable: 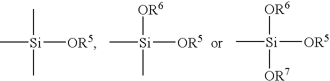
where R⁵, R⁶, and R⁷ independently represent any one of branched or straight-chain alkyl group having a carbon number of 1 to 6, an alicyclic group having a carbon number of 3 to 6, and a substituted or unsubstituted phenyl group.

The resin having a silanol group is preferably coated evenly over the surface of the toner-base particle. For example, the polarity or molecular mass of the resin may be adjusted so as not to impair the compatibility, by which the resin is oriented at the surface, or particles are aggregated and/or adhered, allowing the shell part to be formed. As a result, the surface property or distribution of the amount of charge of toner particle becomes uniform, making it possible to improve or stabilize the mobility of toner.

(12) Examples of the other vinyl monomer include isocyanatoethyl(meth)acrylate, m-isopropenyl-α,α-dimethylbenzyl isocyanate, and the like.

As a copolymer of the vinyl monomers, copolymers including any two or more of monomers of (1) to (12) mentioned above in an arbitrary ratio are suitable. Examples thereof include styrene-(meth)acrylate copolymer, styrene-butadiene copolymer, (meth)acrylic acid-acrylate copolymer, styrene-acrylonitrile copolymer, styrene-maleic anhydride copolymer, styrene-(meth)acrylic acid copolymer, styrene-(meth)acrylic acid-divinylbenzene copolymer, styrene-styrene sulfonic acid-(meth)acrylate copolymer, and the like.

The mass average molecular mass of the vinyl resin is preferably 3,000 to 50,000, more preferably 5,000 to 30,000, and most preferably 7,000 to 20,000. When the mass average molecular mass is less than 3,000, problems may occur; for example, toners adhere firmly to developing unit or the like. When it is more than 50,000, fixing property at low temperatures may be impaired.

The glass transition temperature of the vinyl resin is preferably 40° C. to 80° C. and more preferably 50° C. to 80° C. If the glass transition temperature is more than 80° C., fixing property at low temperature may be deteriorated, and if it is less than 40° C., anti-heat preservability of the toner may be deteriorated.

The acid value of the vinyl resin is preferably 20 mgKOH/g to 250 mgKOH/g, more preferably 25 mgKOH/g to 200 mgKOH/g and most preferably 30 mgKOH/g to 150 mgKOH/g. If the acid value is less than 20 mgKOH/g, the contribution of the vinyl resin to the charge ability of the toner may be lowered. If it is more than 250 mgKOH/g, environmental resistance may be deteriorated because the resulting toner is likely to be affected by moisture or the like.

The content of the vinyl resin in the toner is preferably 10% by mass to 50% by mass of total resin components, more preferably 10% by mass to 30% by mass, and most preferably 10% by mass to 20% by mass. If the content is less than 10% by mass, sufficient amount of the vinyl resin may not be present near the surface of the toner. If it is more than 50% by mass, the ability of toner to form particles may be deteriorated, or the fixing property of toner may be deteriorated.

<Polyester Resin>

The type of the polyester resin used in the present invention is not particularly limited and any polyester resins can be used. Several different polyester resins may be used in combination. Examples of the polyester resin include polycondensates of polyol (1) and polycarboxylic acid (2) that will be described below.

-Polyol-

Examples of the polyol (1) include alkylene glycols (e.g. ethylene glycol, 1,2-propylene glycol, 1,3-propylene glycol, 1,4-butanediol, and 1,6-hexanediol); alkylene ether glycols (e.g. diethylene glycol, triethylene glycol, dipropylene glycol, polyethylene glycol, polypropylene glycol, and polytetramethylene ether glycol); alicyclic diols (e.g. 1,4-cyclohexane dimethanol and hydrogenated bisphenol A); bisphenols (e.g. 4,4′-dihydroxybiphenyls such as bispheonol A, bisphenol F, bisphenol S, and 3,3′-difluoro-4,4′-dihydroxybiphenyl; bis(hydroxyphenyl)alkanes such as bis(3-fluoro-4-hydroxyphenyl)methane, 1-phenyl- 1, 1-bis(3-fluoro-4-hydroxyphenyl)ethane, 2,2-bis(3-fluoro-4-hydroxyphenyl)propane, 2,2-bis(3,5-difuluoro-4-hydroxyphenyl)propane (also known as tetrafluoro bisphenol A), and 2,2-bis(3-hydroxyphenyl)-1,1,1,3,3,3-hexafluoropropane); and bis(4-hydroxyphenyl)ethers such as bis(3-fluoro-4-hydroxyphenyl)ether); adducts of the above-mentioned alicyclic diol with an alkylene oxide such as ethylene oxide, propylene oxide and butylene oxide; adducts of the above-mentioned bisphenol with an alkylene oxide such as ethylene oxide, propylene oxide and butylene oxide; and the like.

Among these, alkylene glycols having a carbon number of 2 to 12 and adducts of bisphenol with an alkylene oxide are preferable, and combination of adducts of bisphenol with an alkylene oxide and alkylene glycols having a carbon number of 2 to 12 is most preferably used.

Further, the polyol (1) include polyaliphatic alcohol having 3 or more valence (e.g. glycerine, trimethylol ethane, trimethylol propane, pentaerythritol, sorbitol); phenols having 3 or more valence (e.g. trisphenol PA, phenol novolac, cresol novolac); adducts of the above-mentioned polyphenol having three or more valences with an alkylene oxide; and the like.

These polyols may be used alone or in combination, but are not limited thereto.

-Polycarboxilic Acid-

Examples of the polycarboxilic acid (2) include alkylene dicarboxylic acids (e.g. succinic acid, adipic acid, sebacic acid); alkenylene dicarboxylic acids (e.g. maleic acid, fumar acid); aromatic dicarboxylic acids (e.g. phthalic acid, isophthalic acid, terephthalic acid, naphthalendicarboxylic acid, 3-fluoroisophthalic acid, 2-fluoroisophthalic acid, 2-fluoroterephthalic acid, 2,4, 5,6-tetrafluoroisophthalic acid, 2,3, 5,6-tetrafluoroterephthalic acid, 5-trifluoromethylisophthalic acid, 2,2-bis(4-carboxyphenyl)hexafluoropropane, 2,2-bis(3-carboxyphenyl)hexafluoropropane, 2,2′-bis(trifluoromethyl)-4,4′-biphenyldicarboxylic acid,. 3,3′-bis(trifluoromethyl)-4,4′-biphenyldicarboxylic acid, 2,2′-bis(trifluoromethyl)-3,3′-biphenyldicarboxylic acid, hexafluoroisopropylidenediphthalic acid anhydride); and the like.

Among these, alkenylene dicarboxylic acids having a carbon number of 4 to 20 and aromatic dicarboxylic acids having a carbon number of 8 to 20 are most preferable.

Further, the polycarboxilic acid having three or more valences include aromatic polycarboxylic acids having a carbon number of 9 to 20 (e.g. trimellitic acid, pyromellitic acid). In addition, anhydrides or lower alkylesters (e.g. methyl esters, ethyl esters, isopropyl esters) of those mentioned above may be used to react with the polyol (1).

These polycaboxylic acids can be used alone or in combination, and the polycaboxylic acid is not limited to those mentioned above.

-Ratio of Polyol and Polycarboxilic Acid-

A ratio of polyol (1) and polycarboxilic acid (2) is preferably 2/1 to 1/1 in terms of the equivalent ratio of hydroxyl group [OH] and carboxyl group [COOH], [OH]/[COOH], more preferably 1.5/1 to 1/1, and most preferably 1.3/1 to 1.02/1.

<Peak Molecular Mass of Polyester Resin>

The polyester resin has a peak molecular mass of preferably from 1,000 to 30,000, more preferably from 1,500 to 10,000, most preferably from 2,000 to 8,000. If the peak molecular mass is less than 1,000, anti-heat preservability may deteriorate. If it is more than 30,000, fixing property at low temperatures may deteriorate.

<Functional Group-containing Modified Polyester Resin (hereinafter, may be referred to as “prepolymer”)>

The polyester resin for use in the present invention comprises a functional group-containing modified polyester resin that can undergo an elongation reaction and/or a crosslinking reaction with an active hydrogen group-containing compound such as amines in order to adjust viscous elasticity, which intends to prevent offset. The functional group-containing modified polyester resin is dissolved sufficiently in an organic solvent due to its relatively low molecular mass before toner particles are formed in an aqueous medium; thus granulation is not prevented. When the organic solvent is removed or during heating for facilitating an elongation reaction and/or a crosslinking reaction, the above-mentioned reaction occurs, resulting in formation of the modified polyester resin having a urethane and/or a urea group that provides sufficient viscous elasticity.

The content of the modified polyester resin having a urethane and/or a urea group in the polyester resin is preferably 25% by mass or less, more preferably 20% by mass or less, and most preferably 15% by mass or less. If the content is more than 25% by mass, fixing property at low temperatures may deteriorate. If the content is 5% by mass or less, the effect is reduced and it is difficult to adjust the resins so as to obtain desired toner properties while maintaining ability to form particles.

The prepolymer comprising an isocyanate group include, for example, those prepared by reacting a polyester which is the polycondensate of polyol (1) and polycarboxilic acid (2) that has an active hydrogen group, further with a polyisocyanate (3). Examples of the active hydrogen group included in the above-mentioned polyester include hydroxyl groups (alcoholic hydroxyl group and phenolic hydroxyl group), amino groups, carboxyl groups, mercapto groups, and the like. Of these, alcoholic hydroxyl group is preferable.

-Polyisocyanate-

Examples of polyisocyanate (3) include aliphatic polyisocyanate (e.g. tetramethylene diusocyanate, hexamethylene diisocyanate, 2,6-diisocyanate methyl caproate); alicyclic polyisocyanate (e.g. isophorone diisocyanate, cyclohexylmethane dilsocyanate); aromatic diisocyanate (e.g. trilene diisocyanate, diphenylmethane diisocyanate); aromatic aliphatic diisocyanate (e.g. α, α, α′, α′-tetramethylxylylene diisocyanate); isocyanurates; and blocked-out polyisocyanates with phenol derivatives, oxime, capro lactam, and the like. These may be used in combination.

-Ratio of Isocyanate Group and Hydroxyl Group-

For the ratio of the polyisocyanate (3), typically, the equivalent ratio of isocyanate group [NCO] to hydroxyl group [OH] of polyester resin that comprises a hydroxyl group, i.e., [NCO]/[OH], is preferably 5/1 to 1/1, more preferably 4/1 to 1.2/1 and most preferably 2.5/1 to 1.5/1. If the [NCO]/[OH] is more than 5, fixing property at low temperature may be deteriorated, and if the molar ratio of the [NCO] is less than 1, the content of urea in the modified polyester is reduced, resulting in the deterioration of off-set resistance.

Typically, the content of the constitutional unit obtained from a polyisocyanate (3) in the prepolymer (A) having an isocyanate group at its ends is preferably 0.5% by mass to 40% by mass, more preferably 1% by mass to 30% by mass and most preferably 2% by mass to 20% by mass. If the content is less than 0.5% by mass, off-set resistance may be deteriorated, and if it is more than 40% by mass, fixing property at low temperature may be deteriorated.

-Number of Isocyanate Group in Prepolymer-

Typically, the number of the isocyanate group contained in one molecule of the prepolymer (A) that comprises an isocyanate group is preferably 1 or more, more preferably 1.5 to 3 on average, and most preferably 1.8 to 2.5 on average. If the number of isocyanate group is less than 1 per molecule, the molecular mass of modified polyester resin after chain-elongation reaction and/or a crosslinking reaction becomes low and off-set resistance may be deteriorated.

-Chain-elongation and/or Crosslinking Agent-

For the chain-elongation and/or crosslinking agent, amines can be used. Examples of amines (B) include diamine (B1), polyamine having 3 or more valence (B2), amino alcohol (B3), amino mercaptan (B4), amino acid (B5), block compound in which the amino group of (B1) to (B5) is blocked (B6), and the like.

Examples of diamine (B1) include aromatic diamine (e.g., phenylene diamine, diethyltoluene diamine, 4,4′-diaminophenylmethane, tetrafluoro-p-xylylene diamine, tetrafluoro-p-phenylene diamine); alicyclic diamine (e.g., 4,4′-diamino-3,3′-dimethyldicyclohexylmethane, diamine cyclohexane, isophorone diamine); aliphatic diamine (e.g., ethylene diamine, tetramethylene diamine, hexamethylene diamine, dodecafluorohexylene diamine, tetracosafluorododecylene diamine); and the like.

Examples of polyamine having 3 or more valence (B2) include diethylene triamine, triethylene tetramine, and the like.

Examples of amino alcohol (B3) include ethanolamine, hydroxyethylaniline and the like.

Examples of amino mercaptan (B4) include aminoethylmercaptan, aminopropylmercaptan, and the like.

Examples of amino acid (B5) include amino propionic acid, amino capric acid, and the like.

Examples of block compound in which the amino group of (B1) to (B5) is blocked (B6) include ketimine compounds, oxazoline compounds, and the like obtained from amines of (B1) to (B5) and ketones (e.g., acetone, methylethylketone, methylbutylketone).

Further optionally, a terminator may be used to stop chain-elongation reaction and/or crosslinking reaction, by which the molecular mass of modified polyester resin after the reaction can be controlled. Examples of terminator include monoamine (e.g. diethylamine, dibutylamine, butylamine, laurylamine), block compounds in which these monoamines are blocked such as ketimine compound, or the like.

-Ratio of Amino Group and Isocyanate Group-

For the ratio of amines (B), typically, the equivalent ratio of isocyanate group [NCO] in the isocyanate group-containing prepolymer (A) to amino group [NHx] in the amines (B), [NCO]/[NHx], is preferably from 1/2 to 2/1, more preferably from 1.5/1 to 1/1.5 and most preferably from 1.2/1 to 1/1.2. When the [NCO]/[NHx] is more than 2, or less than 1/2, the molecular mass of urea-modified polyester (i) becomes low, possibly impairing hot offset resistance.

-Colorant-

The colorants are not particularly limited and any known dyes and pigments can be used. Examples thereof include carbon black, nigrosine dyes, iron black, Naphthol Yellow S, Hansa Yellow (10G, 5G, G), cadmium yellow, yellow iron oxide, yellow ocher, chrome yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, anthracene yellow BGL, isoindolinone yellow, colcothar, red lead oxide, lead red, cadmium red, cadmium mercury red, antimony red, Permanent Red 4R, Para Red, Fire Red, parachlororthonitroaniline red, Lithol Fast Scarlet G, Brilliant Fast Scarlet, Brilliant Carmine BS, Permanent Red (F2R, F4R, FRL, is FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Hello Bordeaux BL, Bordeaux 10B, BON Maroon Light, BON Maroon Medium, eosine lake, Rhodamine Lake B, Rhodamine Lake Y, Alizarine Lake, Thioindigo Red B, Thioindigo Maroon, Oil Red, quinacridone red, Pyrazolone Red, Polyazo Red, Chrome Vermilion, Benzidine Orange, Perynone Orange, Oil Orange, cobalt blue, cerulean blue, Alkali Blue Lake, Peacock Blue Lake, Victoria Blue Lake, metal-free phthalocyanine blue, Phthalocyanine Blue, Fast Sky Blue, Indanthrene Blue (RS, BC), indigo, ultramarine, Prussian blue, Anthraquinone Blue, Fast Violet B, Methyl Violet Lake, cobalt violet, manganese violet, dioxazine violet, Anthraquinone Violet, chrome green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc white, and lithopone, and the like. These may be used alone or in combination.

Typically, the content of the colorant in the toner is preferably 1% by mass to 15% by mass and more preferably 3% by mass to 10% by mass.

The colorant may be used as a master batch being combined with a resin. The binder resin used in the production of master batch or knead with the master batch includes, in addition to the modified or unmodified polyester resins mentioned above, polymers of styrene and substituted styrenes such as polystyrene, poly-p-chlorostyrene and polyvinyl toluene; styrene copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid lo copolymer, and styrene-maleic ester copolymer; polymethyl methacrylates, polybuthyl methacrylates, polyvinyl chlorides, polyvinyl acetates, polyethylenes, polypropylenes, polyesters, epoxy resins, epoxy polyol resins, polyurethanes, polyamides, polyvinyl butyral, polyacrylic acid resin, rosin, modified rosin, terpene resins, aliphatic or alicyclic hydrocarbon resins, aromatic petroleum resins, chlorinated paraffin, paraffin wax, and the like. These may be used alone or in combination.

The master batch can be obtained by mixing and kneading a resin for master batch and the colorant with high shear force. To improve interaction between colorant and resin, an organic solvent may be used. In addition, the “flushing process” in which a wet cake containing colorant can be applied directly, is preferably used because it requires no drying. In the flushing process, a water-based paste containing colorant and water is mixed and kneaded with the resin and an organic solvent so that the colorant moves towards the resin, and that water and the organic solvent are removed. The materials are preferably mixed and kneaded using a triple roll mill and other high-shear dispersing devices.

-Releasing Agent-

The releasing agent for use in the present invention is not particularly limited and may be selected from known agents accordingly. Examples thereof include polyolefin waxes (e.g. polyethylene wax, polypropylene wax); long-chain hydrocarbons (e.g. paraffin wax, Sasol Wax); carbonyl group-containing waxes; and the like. Examples of carbonyl group-containing wax include polyalkanoic acid ester (e.g. carnauba wax, montan wax, trimethylolpropane tribehenate, pentaerythritol tetrabehenate, pentaerythritol diacetate dibehenate, glycerin tribehenate, and 1,18-octadecandiol distearate); polyalkanol ester (e.g. trimellitic tristearate,and distearyl maleate); polyalkanoic acid amide (e.g. ethylenediamine dibehenyl amide); polyalkyl amide (e.g. trimellitic acid tristearyl amide); dialkyl ketone (e.g. distearyl ketone); and the like. Of these carbonyl group-containing waxes, the polyalkanoic acid ester is preferable.

The content of the releasing agent in the toner is preferably from 5% by mass to 15% by mass relative to 100 parts by mass of resin component. When the amount of wax is less than 5 parts by mass relative to the total amount of toner, release effect of wax may be lost, offset resistance of the resultant toner may be limited. When the amount of wax is more than 15 parts by mass, the wax tends to bleed out from the toner particles when the toner is agitated in a developing part so that the wax adheres to a toner control member or a photoconductor, resulting in the occurrence of image noise. This is because the wax melts at low temperature so that the wax is easily affected by a thermal energy and a mechanical energy. When the endothermic peak of the wax during temperature rising, measured by a differential scanning calorimeter (DSC), is from 65° C. to 115° C., the resultant toner can be fixed at low temperatures. The toner with a melting point of less than 65° C. tends to have poor flowability, and the toner with a melting point of more than 115° C. tends to have poor fixing property.

Other elements are not particularly limited and may be selected accordingly. Examples thereof include charge controlling agents, inorganic fine particles, flowability improvers, cleaning ability improvers, magnetic materials, metal soaps, and the like.

-Charge Controlling Agent-

The toner of the present invention may optionally include a charge controlling agent. Any known charge controlling agents can be used. Examples of charge controlling agent include Nigrosine dyes, triphenylmethane dyes, chromium containing-metal complex dyes, molybdic acid chelate pigments, rhodamine dyes, alkoxy amines, quaternary ammonium salts (including fluorine-modified quaternary ammonium salts), alkylamides, phosphoric simple substance or compound thereof, tungsten simple substance or compound thereof, fluoride activators, salicylic acid metallic salt, salicylic acid derivative metallic salt, and the like.

Specific examples thereof include Bontron 03 of a nigrosine dye, Bontron P-51 of a quaternary ammonium salt, Bontron E-82 of an oxynaphthoic acid metal complex, Bontron E-84 of a salicylic acid metal complrex, Bontron E-89 of a phenol condensate by Orient Chemical Industries, Ltd.; TP-302 and TP-415 of a quaternary ammonium salt molybdenum metal complex by Hodogaya Chemical Co.; Copy charge PSY VP2038 of a quaternary ammonium salt, Copy Blue PR of a triphenylmethane derivative and Copy charge NEG VP2036 and Copy charge NX VP434 of a quaternary ammonium salt 20 by Hoechst Ltd.; LRA-901, and LR-147 of a boron metal complex by Japan Carlit Co., Ltd.; copper phthalocyanine, perylene, quinacridone, azo pigment, and other high-molecular mass compounds having functional group of sulfonic acid, carboxyl, quaternary ammonium salt, or the like.

The inorganic fine particle is not particularly limited, and may be selected from known inorganic fine particles accordingly. Specific examples of inorganic fine particles include silica, alumina, titanium oxide, barium titanate, magnesium titanate, calcium titanate, strontium titanate, zinc oxide, tin oxide, quartz sand, clay, mica, silicic pyroclastic rock, diatomaceous earth, chromic oxide, cerium oxide, iron oxide red, antimony trioxide, magnesium oxide, zirconium oxide, barium sulfate, barium carbonate, calcium carbonate, silicon carbide, silicon nitride, and the like. These may be used alone or in combination.

The primary particle diameter of the inorganic fine particle is preferably 5 nm to 2 μm, more preferably 5 nm to 500 nm. The is specific surface area of the inorganic fine particle by BET method is preferably 20 m²/g to 500 m²/g.

The content of the inorganic fine particle in the toner is preferably 0.01% by mass to 5.0% by mass, more preferably 0.01% by mass to 2.0% by mass.

The flowability improver refers to agents by which surface is treated to increase hydrophobicity, and degradation of flowability or charging ability can be prevented even under a high humidified condition. Examples thereof include silane coupling agents, silyl agents, silane coupling agents having fluorinated alkyl group, organic titanate coupling agents, aluminium coupling agents, silicone oils, modified silicone oils, and the like.

Examples of cleaning ability improver for removing residual developer on the photoconductor or primary transferring medium after transferring process include fatty acid metal salts such as zinc stearate, calcium stearate, stearic acid, and the like; polymeric particles manufactured by soap-free emulsion polymerization or the like such as polymethylmethacrylate particles, polystyrene particles; and the like. The polymeric particles preferably have a relatively narrow particle size distribution, and a volume average particle diameter of 0.01 μm to 1 μm.

The magnetic material is not particularly limited, and may be selected from known magnetic materials accordingly. Examples thereof include iron powder, magnetite, ferrite, and the like. Among these, those with white color are preferable in terms of color tone.

<Method for Producing a Toner>

The method for producing a toner of the present invention comprises: dissolving and/or dispersing at least an active hydrogen group-containing compound, a polyester resin, a vinyl resin, a releasing agent, and a colorant in an organic solvent, wherein the polyester resin comprises a functional group-containing modified polyester resin capable of undergoing an elongation reaction and/or a crosslinking reaction with the active hydrogen group-containing compound; and then emulsifying and/or dispersing the dissolved and/or dispersed solution in an aqueous medium, and further comprises other steps as necessary.

The content of the vinyl resin is 10% by mass to 50% by mass of total resin components.

-Organic Solvent-

The organic solvent, in which the polyester resin, colorant, and releasing agent are to be dissolved or dispersed, is preferably a volatile organic solvent having a boiling point of less than 100° C. in terms of easy removal of the solution or dispersion in the later operation. Examples of such organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methylacetate, ethylacetate, methyl ethyl ketone, methyl isobutyl ketone, and the like. These solvents may be used alone or in combination. Among these solvents, esters such as methylacetate and ethylacetate, aromatic solvents such as toluene and xylene, halogenated hydrocarbons such as methylene chloride, 1,2-dichloroethane, chloroform, and carbon tetrachloride are most preferable.

The polyester resin, colorant, and releasing agent may be dissolved or dispersed at the same time, but they are typically dissolved or dispersed individually. The organic solvents to be used when dissolving or dispersing may be different or the same, but considering later treatment of solvents, the same organic solvent is preferably used.

The dissolved or dispersed solution of polyester resin preferably has a resin content of about 40% by mass to about 80% by mass. Too high content makes it difficult to dissolve or disperse the resin. In addition, too high content results in high viscosity; thus it is difficult to handle. Too low content leads to a reduced amount of toner produced. When the modified polyester resin having an isocyanate group at an end thereof is mixed with polyester resin, they may be mixed in the same liquid to prepare a dissolved or dispersed solution, or a dissolved or dispersed solution may be prepared separately. Considering the solubility and viscosity of each resin, it is preferable to prepare a dissolved or dispersed solution separately.

The dissolved or swelling solution of the vinyl resin preferably has a resin content of about 30% by mass to about 70% by mass. Too high resin content makes it difficult to dissolve or swell the resin. In addition, too high resin content results in high viscosity; thus it is difficult to handle. In contrast, too low resin content leads to a reduced amount of toner produced.

The colorant may be dissolved or dispersed in the solvent alone, or may be mixed in the dissolved or dispersed solution of polyester resin. Further, a dispersibility improving agent or another polyester resin may be added as necessary. In addition, the master batch mentioned above may be used.

When a wax insoluble in the organic solvent is used as the releasing agent, the wax is dispersed in the organic solvent. The wax dispersion is prepared by typical methods. Specifically, an organic solvent and the wax are mixed and the mixture is dispersed with a disperser such as a bead mill. In some cases, the dispersion time can be shortened if after mixing of the organic solvent and wax, the mixture is once heated to the melting point of the wax, cooled while stirring, and then dispersed with a disperser such as a bead mill. The waxes may be used in combination and may be mixed with a dispersibility improving agent or another polyester resin.

-Aqueous Medium-

For the aqueous medium, water may be used alone, but water-miscible solvent may be used together with water. Examples of the water-miscible solvent include alcohols (methanol, isopropanol, ethylene grycol, etc.), dimethylformamide, tetrahydrofuran, Cellsolves (methyl cellosolve, etc.), lower ketones (acetone, methyl ethyl ketone, etc.), and the like. Typically, the amount of the aqueous medium to be used relative to 100 parts by mass of toner composition is preferably from 50 parts by mass to 2,000 parts by mass, and more preferably from 100 parts by mass to 1,000 parts by mass. When the amount is less than 50 parts by mass, the toner composition tends to be poorly dispersed, and thereby toner particles having a predetermined particle diameter may not be prepared. When the amount is more than 2,000 parts by mass, the production costs increase.

When the dissolved or dispersed toner composition is dispersed in the aqueous medium, an inorganic dispersing agent or resin fine particles are preferably dispersed in the aqueous medium in advance. This is preferable in that the resultant particles have a sharp particle size distribution and good dispersion stability. Resin fine particles are more preferable. As an inorganic dispersing agent, tricalcium phosphate, calcium carbonate, titanium oxide, colloidal silica, hydroxyl apatite, or the like is used.

Any resins capable of forming an aqueous dispersion thereof can be used for the resin that forms the resin fine particles. The resin may be thermoplastic resin or thermoset resin. Examples of the resin include vinyl resins, polyurethane resins, epoxy resins, polyester resins, polyamide resins, polyimide resins, silicone resins, phenol resins, melamine resins, urea resins, anilline resins, ionomer resins, polycarbonate resins, and the like. Two or more of these resins may be used in combination. Of these, vinyl resins, polyurethane resins, epoxy resins, polyester resins, or combination of these are most preferably used because an aqueous dispersion of fine spherical-shaped resin particles is easily obtained.

The aqueous dispersion of resin fine particles can be prepared from the resin by any method without limitation, and the method can be appropriately selected depending on the application. Examples of suitable preparation method include (1) a direct preparation method of aqueous dispersion of the resin fine particles in which, in the case of the vinyl resin, a vinyl monomer as a raw material is polymerized by suspension-polymerization method, emulsification-polymerization method, seed polymerization method or dispersion-polymerization method; (2) a preparation method of aqueous dispersion of the resin fine particles in which, in the case of the polyaddition and/or condensation resin such as polyester resin, polyurethane resin, or epoxy resin, a precursor (monomer, oligomer or the like) or solvent solution thereof is dispersed in an aqueous medium in the presence of a dispersing agent, and heated or added with a curing agent so as to be cured, thereby obtaining the aqueous dispersion of the resin fine particles; (3) a preparation method of aqueous dispersion of the resin fine particles in which, in the case of the polyaddition and/or condensation resin such as polyester resin, polyurethane resin, or epoxy resin, an arbitrary selected emulsifier is dissolved in a precursor (monomer, oligomer or the like) or solvent solution thereof (preferably being liquid, or being liquidized by heating), and then water is added so as to induce phase inversion emulsification, thereby obtaining the aqueous dispersion of the resin fine particles; (4) a preparation method of aqueous dispersion of the resin fine particles, in which a resin, previously prepared by polymerization method which may be any of addition polymerization, ring-opening polymerization, polyaddition, addition condensation, or condensation polymerization, is pulverized by means of a pulverizing mill such as mechanical rotation-type, jet-type or the like, and classified to obtain resin fine particles, and then the resin fine particles are dispersed in an aqueous medium in the presence of an arbitrary selected dispersing agent, thereby obtaining the aqueous dispersion of the resin fine particles; (5) a preparation method of aqueous dispersion of the resin fine particles, in which a resin, previously prepared by a polymerization method which may be any of addition polymerization, ring-opening polymerization, polyaddition, addition condensation or condensation polymerization, is dissolved in a solvent, the obtained resin solution is sprayed in the form of a mist to thereby obtain resin fine particles, and then the obtained resin fine particles are dispersed in an aqueous medium in the presence of an arbitrary selected dispersing agent, thereby obtaining the aqueous dispersion of the resin fine particles; (6) a preparation method of aqueous dispersion of the resin fine particles, in which a resin, previously prepared by a polymerization method, which may be any of addition polymerization, ring-opening polymerization, polyaddition, addition condensation or condensation polymerization, is dissolved in a solvent, the obtained resin solution is subjected to precipitation by adding a poor solvent or cooling after heating and dissolving, the solvent is sequentially removed to thereby obtain resin fine particles, and then the obtained resin fine particles are dispersed in an aqueous medium in the presence of an arbitrary selected dispersing agent, thereby obtaining the aqueous dispersion of the resin fine particles; (7) a preparation method of aqueous dispersion of the resin fine particles, in which a resin, previously prepared by a polymerization method, which may be any of addition polymerization, ring-opening polymerization, polyaddition, addition condensation or condensation polymerization, is dissolved in a solvent to thereby obtain a resin solution, the resin solution is dispersed in an aqueous medium in the presence of an arbitrary selected dispersing agent, and then the solvent is removed by heating or reduced pressure to thereby obtain the aqueous dispersion of the resin fine particles; (8) a preparation method of aqueous dispersion of the resin fine particles, in which a resin, previously prepared by a polymerization method, which is any of addition polymerization, ring-opening polymerization, polyaddition, addition condensation or condensation polymerization, is dissolved in a solvent to thereby obtain a resin solution, an arbitrary selected emulsifier is dissolved in the resin solution, and then water is added to the resin solution so as to induce phase inversion emulsification, thereby obtaining the aqueous dispersion of the resin fine particles; and the like.

In order to emulsify or disperse in an aqueous medium an oil phase that contains a toner composition, surfactant, water-insoluble inorganic dispersing agent, polymeric protective colloid, or the like can be used as necessary.

-Surfactant-

Examples of surfactant include anionic surfactant, cationic surfactant, nonionic surfactant, ampholytic surfactant, and the like.

Examples of anionic surfactant include alkylbenzene sulfonic acid salts, (α-olefin sulfonic acid salts, phosphoric acid ester, and the like. Among these, an anionic surfactant having fluoroalkyl group is preferable. Examples of anionic surfactant having fluoroalkyl group include fluoroalkyl carboxylic acid having 2 to 10 carbon atoms or metal salt thereof, disodium perfluorooctanesulfonylglutamate, sodium-3-{omega-fluoroalkyl (Carbon number 6 to 11)oxy}-1-alkyl (Carbon number 3 to 4) sulfonate, sodium-3-{omega-fluoroalkanoyl(Carbon number 6 to 8)-N-ethylamino}-1-propanesulfonate, fluoroalkyl (Carbon number 11 to 20) carboxylic acid or metal salt thereof, perfluoroalkyl (Carbon number 7 to 13) carboxylic acid or metal salt thereof, perfluoroalkyl (Carbon number 4 to 12) sulfonic acid or metal salt thereof, perfluorooctanesulfonic acid diethanol amide, N-propyl-N-(2-hydroxyethyl)perfluorooctanesulfone amide, perfluoroalkyl (Carbon number 6 to 10) sulfoneamidepropyltrimethylammonium salt, perfluoroalkyl (Carbon number 6 to 10)-N-ethylsulfonyl glycin salt, monoperfluoroalkyl (Carbon number 6 to 16) ethylphosphate ester, and the like. Examples of commercially available surfactant containing fluoroalkyl group are: Surflon S-111, S-112 and S-113 by Asahi Glass Co.; Frorard FC-93, FC-95, FC-98 and FC-129 by Sumitomo 3M Ltd.; Unidyne DS-101 and DS-102 by Daikin Industries, Ltd.; Megafac F-110, F-120, F-113, F-191, F-812 and F-833 by Dainippon Ink and Chemicals, Inc.; ECTOP EF-102, 103, 104, 105, 112, 123A, 123B, 306A, 501, 201 and 204 by Tohchem Products Co.; Futargent F-100 and F150 by Neos Co.; and the like.

Examples of cationic surfactant include amine salt surfactant, quaternary ammonium salt surfactant, and the like. Examples of amine salt surfactant include alkyl amine salt, aminoalcohol fatty acid derivative, polyamine fatty acid derivative, imidazoline, and the like. Examples of quaternary ammonium salt surfactant include alkyltrimethyl ammonium salt, dialkyldimethyl ammonium salt, alkyldimethyl benzyl ammonium salt, pyridinium salt, alkyl isoquinolinium salt, benzethonium chloride, and the like. Among these, preferable examples are primary, secondary or tertiary aliphatic amine acid having fluoroalkyl group, aliphatic quaternary ammonium salt such as perfluoroalkyl (Carbon number 6 to 10) sulfoneamidepropyltrimethylammonium salt, benzalkonium salt, benzetonium chloride, pyridinium salt, imidazolinium salt, and the like. Specific examples of commercially available product thereof are Surflon S-121 by Asahi Glass Co., Frorard FC-135 by Sumitomo 3M Ltd., Unidyne DS-202 by Daikin Industries, Ltd., Megafack F-150 and F-824 by Dainippon Ink and Chemicals, Inc., Ectop EF-132 by Tohchem Products Co., and Futargent F-300 by Neos Co.

Examples of nonionic surfactant include fatty acid amide derivative, polyhydric alcohol derivative, and the like.

Examples of ampholytic surfactant include alanine, dodecyldi(aminoethyl) glycin, di(octylaminoethyl) glycin, N-alkyl-N,N-dimethylammonium betaine, and the like.

Examples of water-insoluble inorganic dispersing agent include tricalcium phosphate, calcium carbonate, titanium oxide, colloidal silica, hydroxyl apatite, and the like.

Examples of polymeric protective colloid are acids, (meta)acrylic monomers having hydroxyl group, vinyl alcohol or ethers thereof, esters of vinyl alcohol and compound having carboxyl group, amide compounds or methylol compounds thereof, chlorides, monopolymers or copolymers having nitrogen atom or heterocyclic rings thereof, polyoxyethylenes, celluloses, and the like.

Examples of acids include acrylic acid, methacrylic acid, α-cyanoacrylic acid, α-cyanomethacrylic acid, itaconic acid, crotonic acid, fumaric acid, maleic acid, maleic anhydride, and the like. Examples of (meta) acrylic monomers having hydroxyl group include β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3 -chloro-2-hydroxypropyl methacrylate, diethyleneglycol monoacrylic ester, diethyleneglycol monomethacrylic ester, glycerin monoacrylic ester, glycerin monomethacrylic ester, N-methylol acrylamido, N-methylol methacrylamide, and the like. Examples of vinyl alcohol or ethers of vinyl alcohol include vinyl methyl ether, vinyl ethyl ether, vinyl propyl ether, and the like. Examples of esters of vinyl alcohol and compound having carboxyl group include vinyl acetate, vinyl propionate, vinyl butyrate, and the like. Examples of amide compound or methylol compound thereof include acryl amide, methacryl amide, diacetone acrylic amide acid, or methylol thereof, and the like. Examples of chlorides include acrylic chloride, methacrylic chloride, and the like. Examples of monopolymers or copolymers having nitrogen atom or heterocyclic rings thereof include vinyl pyridine, vinyl pyrrolidone, vinyl imidazole, ethylene imine, and the like. Examples of polyoxyethylenes include polyoxyethylene, polyoxypropylene, polyoxyethylene alkylamine, polyoxypropylene alkylamine, polyoxyethylene alkylamide, polyoxypropylene alkylamide, polyoxyethylene nonylphenylether, polyoxyethylene laurylphenylether, polyoxyethylene stearylphenyl ester, polyoxyethylene nonylphenyl ester, and the like. Examples of celluloses include methyl cellulose, hydroxyethyl cellulose, hydroxypropyl cellulose, and the like.

-Method for Dispersion-

The method for dispersion is not particularly limited and the dispersion can be performed by means of known dispersers such as low-speed-shear disperser, high-speed-shear disperser, friction lo disperser, high-pressure-jet disperser, supersonic disperser, and the like. In order to make particle diameter of the dispersing element (oilspot) within a range of 2 μm to 20 μm, high-speed-shear disperser is preferable. When the high-speed shear disperser is used, rotating speed is not particularly limited. However, typically, it is preferably 1,000 rpm to 30,000 rpm and more preferably 5,000 rpm to 20,000 rpm. Typically, the temperature during dispersion is preferably 0° C. to 150° C. and more preferably 20° C. to 80° C. under pressure.

-Removal of Solvent-

In order to remove the organic solvent from the thus prepared emulsified dispersion, known methods can be used. For example, a method in which the temperature of the dispersion is gradually increased under normal or reduced pressure, and the organic solvent in the droplets is completely evaporated and removed can be used.

Elongation and/or Crosslinking Reaction

In order to introduce a modified polyester resin having a urethane and/or a urea group, a modified polyester resin having an isocyanate group at its ends and an amine capable of reacting therewith are added. In this case, the amine may be added to an oil phase before the toner composition is dispersed in an aqueous medium, or the amine may be added to the aqueous medium. The reaction time is determined depending on the reactivity of the isocyanate of the polyester prepolymer with the amine added. Typically, the reaction time is preferably from 1 minute to 40 hours, and more preferably from 1 hour to 24 hours. Typically, the reaction temperature is preferably from 0° C. to 150° C., and more preferably from 20° C. to 98° C. In addition, known catalysts may be used as necessary.

-Washing and Drying-

The toner particles dispersed in an aqueous medium are washed and dried by known techniques. Specifically, the toner particles and the aqueous medium are separated by a centrifugal machine, a filter press, or the like (i.e., solid-liquid separation), and then the resulting toner cake is re-dispersed in ion exchange water at a temperature of from room temperature to about 40° C., followed by pH adjustment with acids or bases, if required. Subsequently, the solid and the liquid are separated again. This operation is repeated several times to remove impurities and surfactants. Then, the toner particles are dried with a flash dryer, a circulating dryer, a vacuum dryer, a vibrating fluid dryer, etc. to obtain toner powder. During this process, fine particles in the solution may be removed by centrifugal separation or the like. In addition, after drying the classification may be carried out with use of known classifier as necessary so that the toner powder can have desired distribution of particle diameter.

-External Treatment-

The obtained toner powder after drying is subjected to mixing with other particles such as charge controlling fine particles and fine particles of fluidizers, and the mixed powder is provided with mechanical impact to thereby fix or fuse the other particles on the toner particles. This allows the prevention of other particles from falling off from the surface of the composite particles obtained. Specific means includes a method in which an impact is imparted by rotating a blade at high speed, and a method in which an impact is imparted by introducing the mixed particles into a high-speed flow and accelerating the speed of the flow so as to make the particles to clash with each other or to make the composite particles to clash with an impact board. Examples of device are angmill by Hosokawa Micron Corporation, modified I-type mill by Nippon Pneumatic Mfg. Co., Ltd. to decrease crushing air pressure, hybridization system by Nara Machinery Co., Ltd., kryptron system by Kawasaki Heavy Industries, Ltd., automatic mortar, and the like.

The toner of the present invention has a peak [A] between 850 cm⁻¹ and 783 cm⁻¹ and a peak [B] between 2834 cm⁻¹ and 2862 cm⁻¹ that are determined by fourier transform infrared-attenuated total reflectance (FTIR-ATR) method. The peak [A] is derived from an aromatic group-containing polyester skeleton, and the peak [B] is derived from a long-chain alkyl group of wax. The ratio, [B]/[A], is preferably less than 0.1, and more preferably 0.08 or less. When the ratio, [B]/[A], is more than 0.1, pollution of processes due to the wax exposed on the surface may occur and cause problems. Specifically, preferably, the colorant and the releasing agent do not exist near the surface of the toner in large amount and are not exposed on the surface of the toner. This does not cause filming to e.g. photoconductor due to the releasing agent. In addition, the toner has stable chargability and environmental resistance, and thus, in the case of full-color image formation, the charge difference between each color, caused by different colorant, can be minimized.

Preferably, the toner has a volume average particle diameter (Dv), volume average particle diameter (Dv)/number average particle diameter (Dn), average circularity, and the like that will be described below.

The toner preferably has a volume average particle diameter (Dv) of from 4.5 μm to 8 μm, and more preferably from 5 μm to 7 μm. When the volume average particle diameter is less than 4.5 μm, various problems may occur in each image forming process, and when it is more than 8 μm, the resolution of the image may deteriorate.

The ratio of the volume average particle diameter (Dv) to the number average particle diameter (Dn), Dv/Dn, in the toner is preferably 1.00 to 1.30, and most preferably 1.00 to 1.20, for example.

The volume average particle diameter and the ratio of the volume average particle diameter to the number average particle diameter, Dv/Dn, can be measured or determined, for example, using a particle size meter “Multisizer II” by Beckman Coulter Inc.

The average circularity can be obtained by dividing the circumference of an equivalent circle having the same area as the projected area of the shape of toner particle by the circumference of actual toner particle. For example, the average circularity is preferably 0.925 to 0.97 and more preferably 0.945 to 0.965. Preferably, the content of the toner having an average circularity of less than 0.925 is 15% or less.

When the average circularity is less than 0.925, sufficient transfer properties or high quality images with no dust may not be obtained. When the average circularity is more than 0.97, it is likely to cause image smears resulted from cleaning failures on the photoconductor or transfer belt in the image-forming system utilizing cleaning blades. Specifically, in the case of image formation having large image area such as photo graphic images, a residual toner resulted from forming untransferred images on the photoconductor due to paper feed failure or the like, is accumulated and causes background smear on the formed image, or pollutes charging rollers that contact-charge the photoconductor, which inhibits charging rollers to exhibit original charging ability.

The average circularity can be measured, for example, by the optical detection zone method in which a suspension containing toner is passed through an image-detection zone disposed on a plate, the particle images of the toner are optically detected by CCD camera, and the obtained particle images are analyzed. For example, the flow-type particle image analyzer FPIA-2100 by Sysmex Corp. may be employed for such method.

The coloration of the toner is not particularly limited and may be selected accordingly. For example, the coloration is at least one selected from black toner, cyan toner, magenta toner and yellow toner. Each color toner is obtained by appropriately selecting the colorant to be contained therein. It is preferably a color toner.

(Developer)

The developer of the present invention at least contains the toner of the present invention and further contains other appropriately selected components such as carrier. The developer can be either one-component developer or two-component developer. However, the two-component developer is preferable in terms of improved life span when the developer is used, for example, in a high-speed printer that corresponds to the improvement of recent information processing speed.

(Process Cartridge)

The process cartridge of the present invention integrally supports at least a photoconductor and a developing unit configured to develop the latent electrostatic image on the photoconductor using the toner of the present invention and further may integrally support charging unit, transferring unit, cleaning unit, discharging unit, and other units selected accordingly. The developing unit at least contains a developer carrier for carrying and transferring the toner and may further contain a layer thickness control member for controlling the thickness of carried toner layer.

The process cartridge of the present invention may be detachably mounted on the body of a variety of image forming apparatuses, facsimiles and printers and is preferably detachably mounted on the image forming apparatus of the present invention, which is described later.

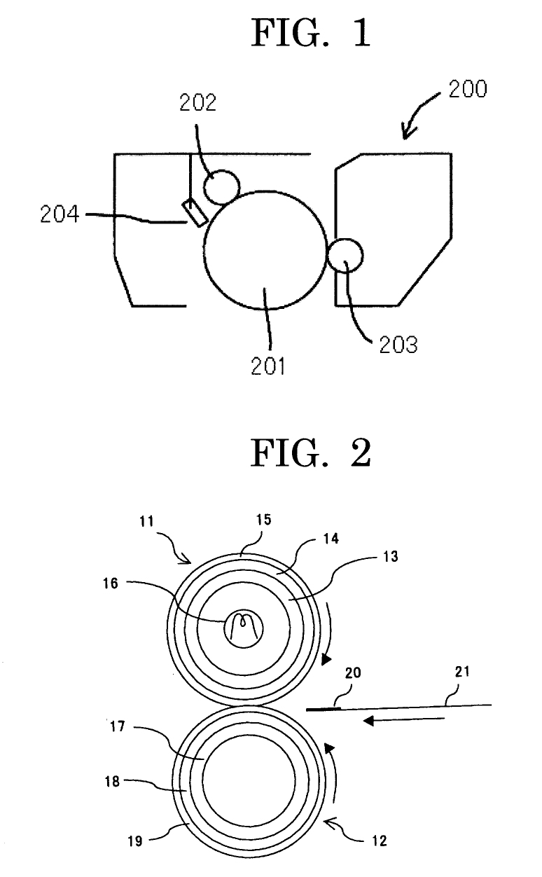

The process cartridge 200 shown in FIG. 1 is equipped with photoconductor 201, charging unit 202, developing unit 203, and cleaning unit 204. To describe operation, the photoconductor 201 is rotationally driven at a predetermined circumferential speed. The photoconductor 201 receives uniform charge of positive or negative predetermined potential from the charging unit 202 in the rotating process, then is exposed to image exposure light from an image exposing unit (not shown) such as a slit exposure and laser beam, and thus latent electrostatic images are sequentially formed on the surface of the photoconductor 201. Thus formed latent electrostatic images are developed by toner with the developing unit 203, developed toner images are sequentially transferred on a recording medium by a transferring unit (not shown), which is fed from a paper-feeding part between the photoconductor and the transferring unit (not shown) so as to match the rotation of the photoconductor. The recording medium having transferred images is separated from the surface of the photoconductor, introduced to a fixing unit (not shown), and images are fixed, and printed out as a copy or print to the outside of the apparatus. The surface of the photoconductor after image transfer is cleaned as a result of removal of residue toner remaining after transfer by the cleaning unit 204, discharged, and then is used for image forming repeatedly.

The image forming apparatus of the present invention forms images using the toner of the present invention. The toner of the present invention can be used both for a one-component developer and for a two-component developer, but preferably, is used as a one-component developer. Preferably, the image forming apparatus of the present invention comprises endless-type intermediate transferring unit. In addition, the image forming apparatus of the present invention preferably comprises a photoconductor and a cleaning unit that cleans residual toner on the photoconductor and/or an intermediate transferring member. In this case, the cleaning unit may comprise a cleaning blade or may not comprise it. The image forming apparatus of the present invention preferably comprises a fixing unit that fixes images by means of a roller that includes a heating device or a belt that includes a heating device. Additionally, the image forming apparatus of the present invention preferably comprises a fixing unit in which application of oil to a fixing member is not required.

Regarding the image forming apparatus of the present invention, components such photoconductor, developing unit and cleaning unit are integrated to form a process cartridge, and this process cartridge may be detachably attached to the body of the image forming apparatus. Also, at least any one of the charging unit, exposure unit, developing unit, transferring unit, separating unit, and cleaning unit is supported with the photoconductor to form the process cartridge as a single unit which can be detachably attached to the body of the image forming apparatus, and the unit may have a detachable configuration by a guiding means such as rail on the apparatus body.

(Image Forming Method and Image Forming Apparatus)

The image forming method of the present invention include latent electrostatic image forming, developing, transferring, fixing and other steps such as discharging, cleaning, recycling, controlling, etc. as necessary.

The image forming apparatus of the present invention contains latent electrostatic image bearing member, latent electrostatic image forming unit, developing unit, transferring unit, fixing unit and other units such as discharging unit, cleaning unit, recycling unit and control unit as necessary.

The latent electrostatic image forming is a step that forms a latent electrostatic image on the latent electrostatic image bearing member.

The material, shape, structure, size, etc. of the latent electrostatic image bearing member (may be referred to as “electrophotographic photoconductor”, “photoconductor”, “image bearing member”) are not limited and may be selected from those known in the art. The latent electrostatic image bearing member is preferably drum-shaped. The materials thereof are, for example, inorganic photoconductors such as amorphous silicon, selenium; organic photoconductors such as polysilane, phthalopolymethine, and the like. Of these examples, amorphous silicon is preferred for its longer operating life.

The latent electrostatic image may be formed, for example, by uniformly charging the surface of photoconductor, and exposing it imagewise, and this may be performed by the latent electrostatic image forming unit. The latent electrostatic image forming unit, for example, contains a charger which uniformly charges the surface of latent electrostatic image bearing member, and an irradiator which exposes the surface of latent electrostatic image bearing member imagewise.

Charging may be performed, for example, by applying a voltage to the surface of latent electrostatic image bearing member using the charger.

The charger is not limited and may be selected accordingly. Examples of charger include known contact chargers equipped with conductive or semi-conductive roller, brush, film or rubber blade and non-contact chargers using corona discharges such as corotron or scorotron, etc.

Exposures may be performed by exposing the surface of photoconductor imagewise using exposure machines, for example.

The exposure machine is not limited as long as it is capable of exposing the surface of photoconductor that has been charged by a charger to form an image as it is expected, and may be selected accordingly. Examples thereof include various exposure machines such as copy optical system, rod lens array system, laser optical system, and liquid crystal shutter optical system, etc.

A backlight system may be employed in the present invention by which the photoconductor is exposed imagewise from the rear surface.

-Developing and Developing Unit-

Developing is a step by which a latent electrostatic image is developed using the toner and/or developer of the present invention to form a visible image.

The visible image may be formed, for example, by developing a latent electrostatic image using the toner and/or developer of the present invention, which may be performed by a developing unit.

The developing unit is not limited as long as it is capable of developing an image by using the toner and/or developer of the present invention, for example, and may be selected from known developing unit accordingly. Suitable examples thereof include those having developing units that contain the toner and/or developer of the present invention and that can supply toners to the latent electrostatic images by contact or with no contact, developing units that contain the toner container are more preferable.

The developing unit may be of dry developing system or wet developing system and may also be for single or multiple colors. Preferred examples include one having mixer whereby toner and/or developer is charged by friction-stirring and rotatable magnet rollers.

In the developing unit, the toner and the carrier may, for example, be mixed and stirred together. The toner is thereby charged by friction, and forms a magnetic brush on the surface of the rotating magnet roller. Since the magnet roller is arranged near the latent electrostatic image bearing member (photoconductor), a part of the toner constructing the magnetic brush formed on the surface of the magnet roller is moved toward the surface of the latent electrostatic image bearing member (photoconductor) due to the force of electrical attraction. As a result, a latent electrostatic image is developed by the use of toner, and a visible toner image is formed on the surface of the photoconductor.

The developer contained in the developing unit is the developer containing the toner of the present invention, and it may be one-component or two-component developer. The toner contained in the developer is the toner according to the present invention.

FIG. 5 shows a developing unit for use in the present invention and the surroundings of a photoconductor 101. In this developing device 100, the toner in a toner hopper 102 is supplied to a developing roller 104 by a supply roller 103. The toner, supplied to the developing roller 104 is charged by the friction between the developing roller 104 and a thin-layer forming member. The toner which was not used for developing is removed from the developing roller 104 by the supply roller 103 and returns the toner hopper 102. In the toner hopper 102, toner is agitated by an agitator 105, by which the toner is maintained evenly. The reference number 106 in FIG. 5 denotes a cleaning unit.

-Transferring and Transferring Unit-

Transferring is a step that transfers the visible image to a recording medium. In a preferable aspect, the first transfer is performed, using an intermediate transferring member by which the visible image is transferred to the intermediate transferring member, and the second transfer is performed wherein the visible image is transferred to the recording medium. In a more preferable aspect, using toner of two or more colors and preferably of full-color, the first transferring is performed by transferring the visible image to the intermediate transferring member to form a compounded transfer image, and the second transferring is performed by transferring the compounded transfer image to the recording medium.

Transferring of the visible image may be carried out, for example, by charging the latent electrostatic image bearing member (photoconductor) using a transferring charger, which can be performed by the transferring unit. In a preferable aspect, the transferring unit contains the first transferring unit which transfers the visible image to the intermediate transferring member to form a compounded transfer image, and the second transferring unit which transfers the compounded transfer image to the recording medium.

The intermediate transferring member is not limited and may be selected from known transferring members and preferred examples include transfer belts.

The transferring units of the first and the second transferring preferably contain an image-transferring unit which releases the visible image formed on the photoconductor to the recording-medium side by charging. There may be one, two or more of the transferring unit.

The transferring unit may be a corona transferring unit based on corona discharge, transfer belt, transfer roller, pressure transfer roller, or adhesion transferring unit, for example.

The recording medium is not limited and may be appropriately selected from known recording mediums (recording papers).

The fixing is a step that fixes the visible image transferred to the recording medium using a fixing unit. The fixing may be carried out for each color when being transferred to the recording medium, or simultaneously when all colors are being laminated.

The fixing unit is not limited and may be selected accordingly, however it is preferably known heat application and pressurization unit. Examples of such unit include a combination of heating roller and pressure roller, and a combination of heating roller, pressure roller, and endless belt, and the like.

The heating temperature in the heat application and pressurization unit is preferably 80° C. to 200° C.

Further, in the present invention, known optical fixing unit may be used in addition to or in place of fixing and fixing unit, depending on the application.

The discharging is a step that applies a discharge bias to the photoconductor to discharge it, and may be performed by a discharging unit.

The discharging unit is not particularly limited as long as it is capable of applying discharge bias to the photoconductor such as discharge lamps, and may be selected from known charge-eliminating units accordingly.

The cleaning is a step in which residual toner on the latent electrostatic image bearing member is removed, and typically performed by a cleaning unit.

Any known cleaning unit that is capable of removing residual electrophotographic toner on the latent electrostatic image bearing member may be used, the cleaning unit may be properly selected from known cleaner and suitable examples include magnetic brush cleaner, electrostatic brush cleaner, magnetic roller cleaner, blade cleaner, brush cleaner, and web cleaner, etc.

The recycling is a step in which the toner removed by the cleaning is recycled for use in the developing, and typically performed by a recycling unit.

The recycling unit may be properly selected from known transport units.

The controlling is a step in which the respective processes are controlled and typically carried out by a controlling unit.

Any known controlling unit that is capable of controlling the performance of each unit may be selected accordingly. Examples include instruments such as sequencers or computers, etc.

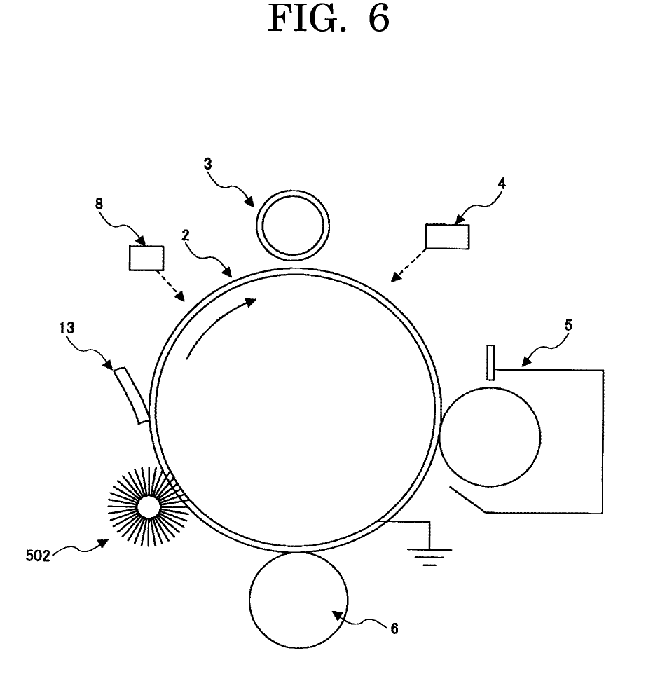

An aspect of the operation of the image forming method of the present invention performed by the image forming apparatus is described referring to FIG. 6. In the image forming apparatus of FIG. 6, a photoconductor 2 is housed in a main body casing which is not shown in the figure. The photoconductor 2 is rotationally driven clockwise in FIG. 6. The image forming apparatus comprises a charging unit 3, exposure unit 4, developing unit 5, transferring unit 6, cleaning unit 13, discharging unit 8, and the like in the surrounding area of the photoconductor 2.

This image forming apparatus is equipped with a feeding cassette (not shown) in which recording papers are placed. The recording papers in the feeding cassette are separated one by one by a feeding roller (not shown). After the timing is adjusted by a pair of resist rollers, the recording paper is fed between the transferring unit 6 and the photoconductor 2.

In the image forming apparatus, a photoconductor 2 is rotationally driven clockwise in FIG. 6, and the photoconductor 2 is uniformly charged by the charging unit 3. Then, the photoconductor 2 is irradiated with the laser, modulated with image data, of the exposure unit 4 to form a latent electrostatic image, and toner is adhered on the photoconductor 2, on which the latent electrostatic image is formed, by the developing unit 5 to develop the latent electrostatic image. Subsequently, a recording paper is transported between the photoconductor 2, on which a toner image is formed by the developing unit 5, and the transferring unit 6 to transfer the toner image on the recording paper. Further, the recording paper, on which the toner image is transferred, is transported to a fixing unit (not shown).

The fixing unit includes a fixing roller and a pressure roller. The fixing roller has a built-in heater that heats the fixing roller to keep at a specified fixing temperature. The pressure roller is pressed by the fixing roller at a specified pressure. The recording paper transported from the transferring unit 6 is heated and pressed, by which the toner image on the recording paper is fixed to the recording paper, and then the recording paper is discharged on a discharge tray (not shown).

In the image forming apparatus, on the other hand, the photoconductor 2, after the transfer of the toner image thereon to the recording paper by the transferring unit 6, is further rotated, and the cleaning unit 13 removes the residual toner on the surface of the photoconductor 2 wherein the residual toner is scraped off by means of a blade. Subsequently, the photoconductor 2 is discharged by the discharging unit 8. In the image forming apparatus, the photoconductor 2, discharged by the discharging unit 8, is uniformly charged by the charging unit 3, and next image is formed in the same manner as described above. The cleaning unit 13 is not limited to those in which the residual toner on the photoconductor 2 is scraped off by means of a blade, and may be those in which the residual toner on the photoconductor 2 is scraped off by means of, for example, a fur brush 502.

According to the present invention, in the production method in which polyester resin and/or modified polyester is dissolved in an organic solvent, particles are formed, and the modified polyester is allowed to undergo an elongation reaction and/or a crosslinking reaction, a vinyl resin is further dissolved or swelled in the organic solvent to form particles. By doing this, a toner in which the vinyl resin is concentrated in the outer part thereof can be obtained, improving the charge ability as well as the charge uniformity. The vinyl resin is required to be dissolved or swelled in the organic solvent sufficiently. When resin fine particles, which are highly self-water dispersible resin, are used, or resin fine particles, stabilized by means of surfactant or the like, such resin fine particles are present as dispersed particles by themselves in the aqueous medium, or are finely dispersed in the manufactured toner. Thus, a desired toner structure cannot be obtained. In addition, an acid value, molecular mass, compatibility with the polyester resin of the vinyl resin, and the like affect uniform formation of vinyl resin layer near the surface of toner after granulation.

The reason why the vinyl resin is advantageous for the control of charge ability is that, for example, (1) different kinds of monomers can be mixed and polymerized, and the monomer is selected flexibly; for example, it is easy to introduce polar groups such as a carboxylic group and sulfonic group, and (2) in emulsion polymerization or suspension polymerization, the structure in the polymer particles can be controlled due to the polarity of monomer.

Desired functional groups derived from the monomer can efficiently be present on the surface of the particle.

Thus, the toner of the present invention that comprises a polyester resin as a main component and a vinyl resin concentrated near the surface has good fixing properties such as fixing property at low temperatures, and has good developability and transferability that are influenced by charge ability.

In the present invention, after the polyester resin, which comprises the functional group-containing modified polyester resin capable of undergoing an elongation reaction and/or a crosslinking reaction with the active hydrogen group-containing compound, vinyl resin, colorant and releasing agent are dissolved or dispersed, the dissolved or dispersed solution is dispersed in an aqueous medium to form toner particles. Therefore, particles with a controlled structure are formed by one-step granulation process, and the method is also excellent in terms of productivity. In conventional suspension-polymerization method or aggregation method, it is not easy to produce a toner with a controlled structure in a one-step 20 process; thus particles are formed through multi-step. This made it difficult to control the final particle diameter of toner. Further, according to the production method of the present invention, after granulation of toner particles, the functional group-containing modified polyester resin and the active hydrogen group-containing compound (e.g. amines) react with each other through an elongation and/or crosslinking reaction, which can provide a toner with better viscous elasticity. In addition, since the active hydrogen group-containing compound form salts together with acid component contained in the resin and is stabilized, an elongation and/or crosslinking reaction does not proceed rapidly when mixed in the organic solvent or during granulation. For this reason, the solubility of resin is not impaired, and ability to form particles is maintained. In contrast, as is well known, in the so-called solution suspension method using a polyester resin, since it is impossible to dissolve polymers that can provide a toner with sufficient elasticity, such polymers cannot be used. Therefore, it is impossible to provide a toner with broad heat characteristic, and satisfactory fixing properties or the like cannot be achieved.

Therefore, the present invention makes it possible to obtain easily a toner that comprises a polyester resin, which gives excellent fixing properties, as a main component and a vinyl resin, which gives excellent charge ability, being concentrated near the surface, wherein the heat characteristic of the polyester resin can be further adjusted through an elongation and/or crosslinking reaction.

### EXAMPLE

Hereinafter, the present invention will be described in detail based on the Examples, but these are not to be construed as limiting the present invention. In the following Examples, all parts are by mass unless otherwise specified.

In the Examples and Comparative Examples described below, various properties were measured or determined by the following methods.

<Volume Average Particle Diameter (Dv) and Particle Size Distribution (Dv/Dn)>

The particle size distribution of a toner was determined using a Coulter Multisizer II (by Beckman Coulter Inc.) as a measuring device for particle size distribution of toner particle according to Coulter counter method.

Initially, 0.1 ml to 5 ml of surfactant (alkylbenzene sulfonate) was added as a dispersing agent to 100 ml to 150 ml of electrolyte. As the electrolyte, ISOTON-II (by Beckman Coulter Inc.) was used that is 1% by mass NaCl aqueous solution prepared using a first grade sodium chloride. Further, 2 mg to 20 mg of sample, in terms of solid content, to be measured was added to the mixture. The electrolyte, in which the sample was suspended, was subjected to a dispersion treatment by an ultrasonic disperser for 1 minute to 3 minutes. The volume and the number of the toner particles or toner were measured by the above-mentioned measuring device using an aperture of 100 μm to determine the volume distribution and number distribution thereof. The volume average particle diameter (Dv) and number average particle diameter (Dn) of the toner were determined from the obtained distributions.

As channels, there were used 13 channels of from 2.00 μm to less than 2.52 μm; from 2.52 μm to less than 3.17 μm; from 3.17 μm to less than 4.00 μm; from 4.00 μm to less than 5.04 μm; from 5.04 μm to less than 6.35 μm; from 6.35 μm to less than 8.00 μm; from 8.00 μm to less than 10.08 μm; from 10.08 μm to less than 12.70 μm; from 12.70 μm to less than 16.00 μm; from 16.00 μm to less than 20.20 μm; from 20.20 μm to less than 25.40 μm; from 25.40 μm to less than 32.00 μm; and from 32.00 μm to less than 40.30 μm; particles having a particle diameter of from 2.00 μm to less than 40.30 μm can be measured.

<Average Circularity>

The average circularity of the toner was measured by a flow type particle image analyzer, FPIA-2100. Specifically, the measurement was performed as follows. 0.1 ml to 0.5 ml of alkylbenzene sulfonate surfactant as a dispersing agent was added to 100 ml to 150 ml of water, in a container, from which solid impurities had been removed in advance and then 0.1 g to 0.5 g of sample to be measured was further added. The suspension, in which the sample was dispersed, was subjected to a dispersion treatment by an ultrasonic disperser for 1 minute to 3 minutes, and the toner shapes and distribution were measured by the above apparatus at a dispersion concentration of 3,000/μl to 10,000/μl to obtain the average circularity.

<Mass Average Molecular Mass>

The mass average molecular mass of the polyester resin and vinyl resin to be used was determined by GPC (Gel Permeation Chromatography) under the following conditions:

Instrument: HLC-8220GPC (by Tosoh Corporation)

Column: TSKgel SuperHZM-M×3

Temperature: 40° C.

Solvent: Tetrahydrofuran (THF)

Flow rate: 0.35 ml/min

Sample: 0.01 ml of sample having a resin content of 0.05% to 0.6% was injected

The mass average molecular mass was determined while comparing the molecular distribution curve thereof with the working curve which was previously prepared using monodisperse polystyrene standard samples. 10 polystyrene standard samples were used, each having a molecular weight of 5.8×100, 1.085×10,000, 5.95×10,000, 3.2×100,000, 2.56×1,000,000, 2.93×1,000, 2.85×10,000, 1.48×100,000, 8.417×100,000, and 7.5×1,000,000.

<Glass Transition Temperature>

The glass transition temperature (Tg) of the resins used such as polyester resin and vinyl resin was determined using a differential scanning calorimeter (DSC-6220R manufactured by Seiko Instruments Inc.) as follows. Initially, a sample was heated from room temperature to 150° C. at a temperature rising rate of 10° C./min. After being allowed to stand at 150° C. for 10 minutes, the sample was cooled to room temperature and allowed to stand for is 10 minutes. The sample was heated again from room temperature to 150° C. at a temperature rising rate of 10° C./min; Tg was determined by finding the point of a curve at which the height between a baseline for the curve not more than the glass transition temperature and a baseline for the curve not less than the glass transition temperature is 1/2.

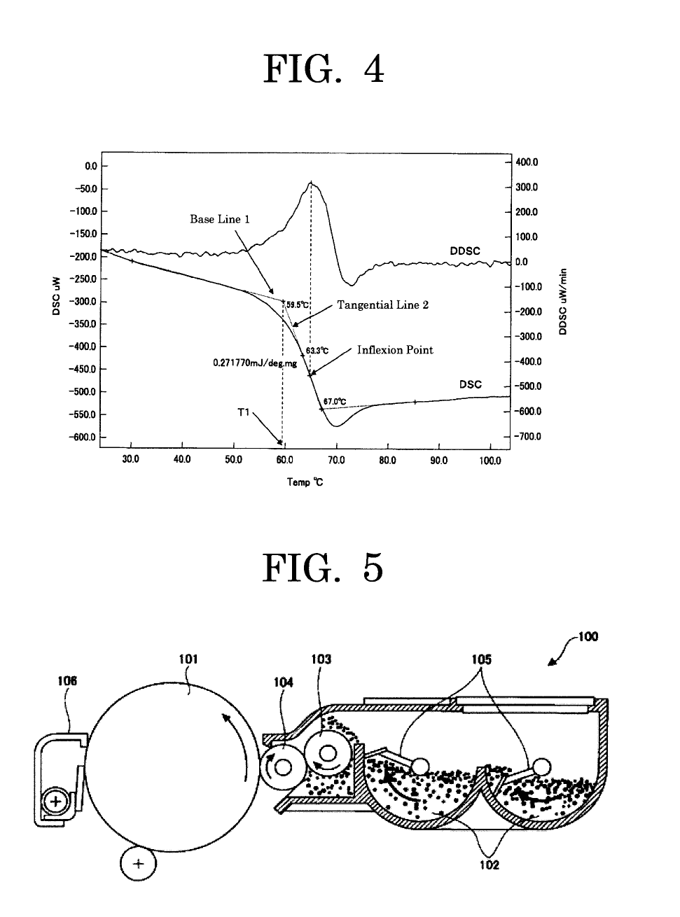

FIG. 4 illustrates a method for determing a glass transition temperature from DSC line and DDSC line. With reference to FIG. 4, the glass transition temperature (Tg) is represented by the temperature T1 at which transition starts. T1 is the temperature at the intersection of a base line 1 (broken line) and a tangential line 2 (broken line) at DSC inflexion point in the transition area (corresponding to peak top of DDSC) wherein the base line 1 is the DSC line before the transition in the 2nd Run temperature rising process and in the range where DDSC is 0±20.

<Average Particle Diameter of Resin Fine Particles>

The average particle diameter of the resin fine particles can be determined by measuring directly the dispersion by use of particle size distribution measuring apparatus (LA-920 by Horiba Ltd.).

<Method for Measuring Acid Value and Hydroxyl Value of Resin>

The acid value (AV) and hydroxyl value (OHV) were determined specifically by the following procedure. When a sample was not dissolved, dioxane, THF, or the like was used as a solvent.

Measuring apparatus: Potentiometric Automatic Titrator DL-53 (by Mettler-Toledo, Inc.)

Electrode: DG113-SC (by Mettler-Toledo, Inc.)

Analysis software: LabX Light Version 1.00.000

Composition of apparatus: A mixed solvent of 120 ml of toluene and 30 ml of ethanol was used.

Measuring temperature: 23° C.

Measurement was carried out under the following condition:

Stir

Speed[%] 25
Time[s] 15
   EQP titration
Titrant/Sensor
Titrant CH₃ONa
Concentration[mol/L] 0.1
Sensor DG115
   Unit of measurement mV
Predispensing to volume
   Volume[mL] 1.0
Wait time[s] 0
Titrant addition Dynamic
   dE(set)[mV] 8.0
   dV(min)[mL] 0.03
   dV(max)[mL] 0.5
Measure mode Equilibrium controlled
   dE[mV] 0.5
   dt[s] 1.0
   t(min)[s] 2.0
   t(max)[s] 20.0
Recognition
   Threshold 100.0
Steepest jump only No
   Range No
   Tendency None
Termination
   At maximum volume[mL] 10.0
   At potential No
   At slope No
   After number EQPs Yes
   n=1
   comb. Termination conditions No
Evaluation
   Procedure Standard
   Potential 1 No
   Potential 2 No
   Stop for reevaluation No
   The acid value was measured based on the measuring method described in JIS K0070-1992 under the following conditions. Sample preparation: 0.5 g of toner (0.3 g for ethyl acetate-soluble component) was added to 120 ml of toluene, and the mixture was agitated at a room temperature (23° C.) for about 10 hours, and dissolved. Further, 30 ml of ethanol was added to prepare a sample solution.

The acid value can be calculated with the above-mentioned apparatus, and specifically, calculated as follows.

The sample was titrated with a preliminary standardized N/10 caustic potash-alcohol solution, and the acid value was determined from the consumed amount of the alcoholic potassium solution based on the following Equation:

Acid value=KOH (in ml)×N×56.1/mass of sample, where N denotes the factor of N/10KOH in N/10 KOH.

-Measuring Method of Hydroxyl Value-

In a 100-ml volumetric flask, 0.5 g of sample was precisely weighed, to which 5 ml of acetylating reagent was properly added. Then, the flask was immersed and heated in a bath at 100° C.±5° C. After one to two hours, the flask was removed from the bath and stood to cool. Then, water was added and the flask was shaken to decompose acetic anhydride. Next, in order to decompose completely, the flask was again heated in a bath for 10 minutes or more and stood to cool, and the wall of the flask was rinsed well with an organic solvent. This solution was potentiometrically titrated with an N/2 ethyl alcohol solution of potassium hydroxide using the electrode to determine the hydroxyl value (based on JIS K0070-1966).

### Synthetic Example 1

-Synthesis of Polyester Resin1-

In a reaction vessel equipped with condenser tube, stirrer, and nitrogen inlet tube, 553 parts of bisphenol A ethyleneoxide dimole adduct, 196 parts of bisphenol A propylene oxide dimole adduct, 220 parts of terephthalic acid, 45 parts of adipic acid, and 2 parts of dibutyl tin oxide were placed, and the reaction was performed under normal pressure at 230° C. for 8 hours. Further, the reaction was performed under a reduced pressure of 10 mmHg to 15 mmHg for 5 hours. Then, 26 parts of trimellitic anhydride was placed in the reaction vessel, and the reaction was performed under normal pressure at 180° C. for 2 hours to prepare “polyester resin 1”. The “polyester resin 1” had a number average molecular mass of 2,200, a mass average molecular mass of 5,600, a glass transition temperature (Tg) of 43° C., and an acid value of 24 mgKOH/g.

### Synthetic Example 2

-Synthesis of Vinyl Copolymer Resin V-1-

In a reaction vessel, 200 parts of tetrahydrofuran was placed, and the temperature was raised to a reflux temperature. A mixture of 60 parts of styrene monomer, 25 parts of n-butyl acrylate, 15 parts of methacrylic acid, 2 parts of octyl mercaptan, and 1 part of 2,2′-azobisisobutyronitrile was dropped therein over 4 hours. Further, a mixture of 0.1 part of 2,2′-azobisisobutyronitrile and 5 parts of tetrahydrofuran was dropped, polymerization was completed under reflux, and tetrahydrofuran was removed to obtain “vinyl copolymer resin V-1”. The “vinyl copolymer resin V-1” had a number average molecular mass of 3,200, a mass average molecular mass of 8,500, a glass transition temperature (Tg) of 61° C., and an acid value of 95 mgKOH/g.

### Synthetic Example 3

-Synthesis of Vinyl Copolymer Resin V-2-

In a reaction vessel, 200 parts of tetrahydrofuran was placed, and the temperature was raised to a reflux temperature. A mixture of 60 parts of styrene monomer, 25 parts of n-butyl acrylate, 15 parts of methacrylic acid, 2 parts of octyl mercaptan, and 1 part of 2,2′-azobisisobutyronitrile was dropped therein over 4 hours. Further, a mixture of 0.1 part of 2,2′-azobisisobutyronitrile and 5 parts of tetrahydrofuran was dropped, polymerization was completed under reflux, and tetrahydrofuran was removed to obtain “vinyl copolymer resin V-2”. The “vinyl copolymer resin V-2” had a number average molecular mass of 4,400, a mass average molecular mass of 10,500, a glass transition temperature (Tg) of 67° C., and an acid value of 30 mgKOH/g.

### Synthetic Example 4

-Synthesis of Vinyl Copolymer Resin V-3-

In a reaction vessel, 200 parts of tetrahydrofuran was placed, and the temperature was raised to a reflux temperature. A mixture of 77 parts of styrene monomer, 20 parts of n-butyl acrylate, 3 parts of methacrylic acid, 1.1 parts of octyl mercaptan, and 1 part of 2,2′-azobisisobutyronitrile was dropped therein over 4 hours. Further, a mixture of 0.1 part of 2,2′-azobisisobutyronitrile and 5 parts of tetrahydrofuran was dropped, polymerization was completed under reflux, and tetrahydrofuran was removed to obtain “vinyl copolymer resin V-3”. The “vinyl copolymer resin V-3” had a number average molecular mass of 8,300, a mass average molecular mass of 21,000, a glass transition temperature (Tg) of 64° C., and an acid value of 20 mgKOH/g.

### Synthetic Example 5

-Synthesis of Vinyl Copolymer Resin V-4-

In a reaction vessel, 200 parts of tetrahydrofuran was placed, and the temperature was raised to a reflux temperature. A mixture of 58 parts of styrene monomer, 22 parts of n-butyl acrylate, 20 parts of methacrylic acid, 1.5 parts of octyl mercaptan, and 1 part of 2,2′-azobisisobutyronitrile was dropped therein over 4 hours. Further, a mixture of 0.1 part of 2,2′-azobisisobutyronitrile and 5 parts of tetrahydrofuran was dropped, polymerization was completed under reflux, and tetrahydrofuran was removed to obtain “vinyl copolymer resin V-4”. The “vinyl copolymer resin V-4” had a number average molecular mass of 5,800, a mass average molecular mass of 13,000, a glass transition temperature (Tg) of 69° C., and an acid value of 128 mgKOH/g.

### Synthetic Example 6

-Synthesis of Vinyl Copolymer Resin V-5-

In a reaction vessel, 200 parts of tetrahydrofuran was placed, and the temperature was raised to a reflux temperature. A mixture of 46 parts of styrene monomer, 24 parts of n-butyl acrylate, 30 parts of methacrylic acid, 1.2 parts of octyl mercaptan, and 1 part of 2,2′-azobisisobutyronitrile was dropped therein over 4 hours. Further, a mixture of 0.1 part of 2,2′-azobisisobutyronitrile and 5 parts of tetrahydrofuran was dropped, polymerization was completed under reflux, and tetrahydrofuran was removed to obtain “vinyl copolymer resin V-5”. The “vinyl copolymer resin V-5” had a number average molecular mass of 7,200, a mass average molecular mass of 17,600, a glass transition temperature (Tg) of 75° C., and an acid value of 212 mgKOH/g.

### Synthetic Example 7

-Synthesis of Vinyl Copolymer Resin V-6-

In a reaction vessel, 200 parts of tetrahydrofuran was placed, and the temperature was raised to a reflux temperature. A mixture of 83 parts of styrene monomer, 16 parts of n-butyl acrylate, 1 part of methacrylic acid, 1.5 parts of octyl mercaptan, and 1 part of 2,2′-azobisisobutyronitrile was dropped therein over 4 hours. Further, a mixture of 0.1 part of 2,2′-azobisisobutyronitrile and 5 parts of tetrahydrofuran was dropped, polymerization was completed under reflux, and tetrahydrofuran was removed to obtain “vinyl copolymer resin V-6”. The “vinyl copolymer resin V-6” had a number average molecular mass of 4,500, a mass average molecular mass of 10,200, a glass transition temperature (Tg) of 70° C., and an acid value of 6 mgKOH/g.

### Synthetic Example 8

-Synthesis of Vinyl Copolymer Resin V-7-

In a reaction vessel, 200 parts of tetrahydrofuran was placed, and the temperature was raised to a reflux temperature. A mixture of 30 parts of styrene monomer, 30 parts of n-butyl acrylate, 40 part of methacrylic acid, 1.5 parts of octyl mercaptan, and 1 part of 2,2′-azobisisobutyronitrile was dropped therein over 4 hours. Further, a mixture of 0.1 part of 2,2′-azobisisobutyronitrile and 5 parts of tetrahydrofuran was dropped, polymerization was completed under reflux, and tetrahydrofuran was removed to obtain “vinyl copolymer resin V-7”. The “vinyl copolymer resin V-7” had a number average molecular mass of 3,800, a mass average molecular mass of 9,800, a glass transition temperature (Tg) of 72° C., and an acid value of 256 mgKOH/g.

### Synthetic Example 9

-Synthesis of Vinyl Copolymer Resin V-8-

In a reaction vessel, 200 parts of tetrahydrofuran was placed, and the temperature was raised to a reflux temperature. A mixture of 55 parts of styrene monomer, 35 parts of n-butyl acrylate, 10 part of methacrylic acid, 1.2 parts of octyl mercaptan, and 1 part of 2,2′-azobisisobutyronitrile was dropped therein over 4 hours. Further, a mixture of 0.1 part of 2,2′-azobisisobutyronitrile and 5 parts of tetrahydrofuran was dropped, polymerization was completed under reflux, and tetrahydrofuran was removed to obtain “vinyl copolymer resin V-8”. The “vinyl copolymer resin V-8” had a number average molecular mass of 7,100, a mass average molecular mass of 16,800, a glass transition temperature (Tg) of 39° C., and an acid value of 61 mgKOH/g.

The properties of synthesized resins are listed in Table 1

TABLE 1

| | | | Acid Value |
|---|---|---|---|
| Type | Mw | Tg | (mgKOH/g) |
| Polyester Resin 1 | 5,600 | 43° C. | 24 |
| Vinyl Resin V-1 | 8,500 | 61° C. | 95 |
| Vinyl Resin V-2 | 10,500 | 67° C. | 30 |
| Vinyl Resin V-3 | 21,000 | 64° C. | 20 |
| Vinyl Resin V-4 | 13,000 | 69° C. | 128 |
| Vinyl Resin V-5 | 17,600 | 75° C. | 212 |
| Vinyl Resin V-6 | 10,200 | 70° C. | 6 |
| Vinyl Resin V-7 | 9,800 | 72° C. | 256 |
| Vinyl Resin V-8 | 16,800 | 39° C. | 61 |
| Reaction Product of | — | — | — |
| Prepolymer and Amine (HP) | | | |

### Example 1

-Production of Prepolymer-

In a reaction vessel equipped with condenser tube, stirrer, and nitrogen inlet tube, 682 parts of bisphenol A ethyleneoxide dimole adduct, 81 parts of bisphenol A propylene oxide dimole adduct, 283 parts of terephthalic acid, 22 parts of trimellitic anhydride and 2 parts of dibutyl tin oxide were placed, and the reaction was performed under normal pressure at 230° C. for 8 hours. Further, the reaction was performed under a reduced pressure of 10 mmHg to 15 mmHg for 5 hours to prepare “intermediate polyester 1”. The obtained “intermediate polyester 1” had a number average molecular mass of 2,100, a mass average molecular mass of 9,500, a is glass transition temperature (Tg) of 55° C., an acid value of 0.5 mgKOH/g, and a hydroxyl value of 49 mgKOH/g.

Next, in a reaction vessel equipped with condenser tube, stirrer, and nitrogen inlet tube, 411 parts of “intermediate polyester 1”, 89 parts of isophorone diisocyanate and 500 parts of ethyl acetate were placed. The reaction was performed at 100° C. for 5 hours to prepare “prepolymer 1”. The content of free isocyanate in the obtained “prepolymer 1” was 1.53% by mass.

Synthesis of Master Batch

40 parts of carbon black (REGAL 400R by Cabot Corporation), 60 parts of polyester resin (RS801 by Sanyo Chemical Industries, Ltd., acid value: 10 mgKOH/g, mass average molecular mass (Mw): 20,000, glass transition temperature (Tg): 64° C.), and 30 parts of water were mixed with HENSCHEL MIXER to obtain a mixture in which water was infiltrated into a pigment aggregate. Then the mixture was kneaded for 45 minutes using two rollers, the surface temperature of which was set to 130° C., and crushed into particles having a size of 1 mm in diameter with a pulverizer to prepare “masterbatch K”.

Further, “masterbatch Y”, “masterbatch M”, and “masterbatch C” were prepared using as a pigment C.I.Pigment Yellow 180, C.I.Pigment Red 184, C.I.Pigment Blue 15:3, respectively, instead of carbon black.

-Preparation of Pigment/Wax Dispersion (Oil Phase)-

126 parts of “polyester 1”, 42 parts of paraffin wax (melting point: 72° C.) and 438 parts of ethyl acetate were introduced into a vessel provided with stirrer and thermometer, and the temperature was raised to 80° C. with stirring, maintained at 80° C. for 5 hours, and cooled to 30° C. over 1 hour. Next, 137 parts of“masterbatch K” was added to the vessel and mixed for 1 hour. The mixture was transferred to another vessel, and pigment and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes to obtain “raw material solution 1”. Next, to 372 parts of “raw material solution 1”, 286 parts of 70% ethyl acetate solution of the “polyester 1” and 85 parts of dispersion of “vinyl resin 1” dissolved in 50% ethyl acetate were added and stirred with Three-One Motor for 2 hours to obtain “pigment/wax dispersion 1”. Ethyl acetate was added to adjust the concentration so that a solid content, measured at 130° C., 30 minutes, of the “pigment/wax dispersion 1” was 50% by mass.

-Preparation of Aqueous Phase

838 parts of ion exchange water, 40 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 162 parts of an aqueous solution of sodium dodecyl diphenyl ether disulfonate (ELEMINOL MON-7 by Sanyo Chemical Industries Ltd., content of 50% by mass), 202 parts of an aqueous solution of carboxymethylcellulose (content of 1% by mass) as a thickener, and 108 parts of ethyl acetate were mixed and stirred together to obtain a milky liquid. This is referred to as “aqueous phase 1”.

-Emulsification-

To the total amount of “pigment/wax dispersion 1”, 1.56 parts of isohorone diamine as an amine was added and mixed in a TK homomixer by Tokushu Kika Kogyo Co., Ltd. at 5,000 rpm for 1 minute. Then 108 parts of “prepolymer 1” was added and mixed in a TK homomixer by Tokushu Kika Kogyo Co., Ltd. at 5,000 rpm for is 1 minute, and 1,340 parts of “aqueous phase 1” was added and mixed in a TK homomixer for 20 minutes while adjusting the rotation speed between 8,000 rpm to 13,000 rpm to obtain “emulsion slurry 1”.

-Removal of Solvent-

The “emulsion slurry 1” was placed in a vessel equipped with stirrer and thermometer, and the solvent was removed at 30° C. for 8 hours to obtain “dispersion slurry 1”.

-Washing and Drying-

1,000 parts of “dispersion slurry 1” was filtered under the reduced pressure, then

(1) 1,000 parts of ion exchange water were added to the filter cake and mixed in a TK homomixer at a rotation speed of 12,000 rpm for 10 minutes and filtered.

(2) 1,000 parts of ion exchange water were added to the filter cake of (1), mixed for 30 minutes in a TK homomixer at a rotation speed of 12,000 rpm with applying an ultrasonic wave and then filtered under the reduced pressure. This operation was repeated until an electric conductivity of reslurry solution was not greater than 10 μC/cm.

(3) 10% by mass hydrochloric acid was added to the reslurry solution of the filter cake of (2) so that pH of the reslurry solution was 4, stirred with Three-One Motor for 30 minutes, and then filtered.

(4) 1,000 parts of ion exchange water were added to the filter cake of (3), mixed in a TK homomixer at a rotation speed of 12,000 rpm for 10 minutes, and then filtered. This operation was repeated until an electric conductivity of reslurry solution was not greater than 10 μC/cm to obtain “filter cake 1”.

The “filter cake 1” was dried in a circulating air dryer at 45° C. for 48 hours, and sieved through a sieve of 75 μm mesh to obtain “toner-base particle 1”.

The obtained toner-base particle 1 had a volume average particle diameter (Dv) of 6.2 μm, a number average particle diameter (Dp) of 5.5 μm, a Dv/Dp of 1.13, and an average circularity of 0.973.

Next, to 100 parts of the mother toner 0.5 parts of hydrophobized silica and 0.5 parts of hydrophobized titanium oxide were mixed in HENSCHEL MIXER to prepare “developer 1K”.

Further, “developer IY”, “developer IM”, and “developer IC” were prepared in the same way as in “developer 1K” by changing “masterbatch K” to “masterbatch Y”, “masterbatch M”, and “masterbatch C”, respectively.

### Example 2

-Preparation of Pigment/Wax Dispersion (Oil Phase)-

126 parts of “polyester 1”, 42 parts of paraffin wax (melting point: 72° C.) and 438 parts of ethyl acetate were introduced into a vessel provided with stirrer and thermometer, and the temperature was raised to 80° C. with stirring, maintained at 80° C. for 5 hours, and cooled to 30° C. over 1 hour. Next, 137 parts of “masterbatch K” was added to the vessel and mixed for 1 hour. The mixture was transferred to another vessel, and pigment and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes to obtain “raw material solution 2”. Next, to 372 parts of “raw material solution 2”, 235 parts of 70% by mass ethyl acetate solution of the “polyester 1” and 169 parts of dispersion of “vinyl resin 1” dissolved in 50% by mass ethyl acetate were added and stirred with Three-One Motor for 2 hours to obtain “pigment/wax dispersion 2”. Ethyl acetate was added to adjust the concentration so that a solid content, measured at 130° C., 30 minutes, of the “pigment/wax dispersion 2” was 50% by mass.

-Preparation of Aqueous Phase

838 parts of ion exchange water, 40 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 162 parts of an aqueous solution of sodium dodecyl diphenyl ether disulfonate (ELEMINOL MON-7 by Sanyo Chemical Industries Ltd., content of 50% by mass), 202 parts of an aqueous solution of carboxymethylcellulose (content of 1% by mass) as a thickener, and 108 parts of ethyl acetate were mixed and stirred together to obtain a milky liquid. This is referred to as “aqueous phase 2”.

-Emulsification-

To the total amount of “pigment/wax dispersion 2”, 1.38 parts of isohorone diamine as an amine was added and mixed in a TK homomixer by Tokushu Kika Kogyo Co., Ltd. at 5,000 rpm for 1 minute. Then 95 parts of “prepolymer 1” was added and mixed in a TK homomixer by Tokushu Kika Kogyo Co., Ltd. at 5,000 rpm for 1 minute, and 1,340 parts of “aqueous phase 2” was added and mixed in a TK homomixer for 20 minutes while adjusting the rotation speed between 8,000 rpm to 13,000 rpm to obtain “emulsion slurry 2”.

Thereafter, procedures of Example 1 were repeated to prepare “developer 2K”, “developer 2Y”, “developer 2M”, and “developer 2C”.

### Example 3

-Preparation of Pigment/Wax Dispersion (Oil Phase)-

126 parts of “polyester 1”, 42 parts of paraffin wax (melting point: 72° C.) and 438 parts of ethyl acetate were introduced into a vessel provided with stirrer and thermometer, and the temperature was raised to 80° C. with stirring, maintained at 80° C. for 5 hours, and cooled to 30° C. over 1 hour. Next, 137 parts of “masterbatch K” was added to the vessel and mixed for 1 hour. The mixture was transferred to another vessel, and pigment and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes to obtain “raw material solution 3”. Next, to 372 parts of “raw material solution 1”, 261 parts of 70% by mass ethyl acetate solution of the “polyester 1” and 127 parts of dispersion of “vinyl resin 2” dissolved in 50% by mass ethyl acetate were added and stirred with Three-One Motor for 2 hours to obtain “pigment/wax dispersion 3”. Ethyl acetate was added to adjust the concentration so that a solid content, measured at 130° C., 30 minutes, of the “pigment/wax dispersion 3” was 50% by mass.

-Preparation of Aqueous Phase

838 parts of ion exchange water, 40 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 162 parts of an aqueous solution of sodium dodecyl diphenyl ether disulfonate (ELEMINOL MON-7 by Sanyo Chemical Industries Ltd., content of 50% by mass), 202 parts of an aqueous solution of carboxymethylcellulose (content of 1% by mass) as a thickener, and 108 parts of ethyl acetate were mixed and stirred together to obtain a milky liquid. This is referred to as “aqueous phase 3”.

- Emulsification-

To the total amount of “pigment/wax dispersion 3”, 1.47 parts of isohorone diamine as an amine was added and mixed in a TK homomixer by Tokushu Kika Kogyo Co., Ltd. at 5,000 rpm for 1 minute. Then 101.4 parts of“prepolymer 1” was added and mixed in a TK homomixer by Tokushu Kika Kogyo Co., Ltd. at 5,000 rpm for 1 minute, and 1,340 parts of “aqueous phase 3” was added and mixed in a TK homomixer for 20 minutes while adjusting the rotation speed between 8,000 rpm to 13,000 rpm to obtain “emulsion slurry 3”.

Thereafter, procedures of Example 1 were repeated to prepare “developer 3K”, “developer 3Y”, “developer 3M”, and “developer 3C”.

### Example 4

-Preparation of Pigment/Wax Dispersion (Oil Phase)-

126 parts of “polyester 1”, 42 parts of paraffin wax (melting point: 72° C.) and 438 parts of ethyl acetate were introduced into a vessel provided with stirrer and thermometer, and the temperature was raised to 80° C. with stirring, maintained at 80° C. for 5 hours, and cooled to 30° C. over 1 hour. Next, 137 parts of “masterbatch K” was added to the vessel and mixed for 1 hour. The mixture was transferred to another vessel, and pigment and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes to obtain “raw material solution 4”. Next, to 372 parts of “raw material solution 4”, 210 parts of 70% by mass ethyl acetate solution of the “polyester 1” and 211 parts of dispersion of “vinyl resin 2” dissolved in 50% by mass ethyl acetate were added and stirred with Three-One Motor for 2 hours to obtain “pigment/wax dispersion 4”. Ethyl acetate was added to adjust the concentration so that a solid content, measured at 130° C., 30 minutes, of the “pigment/wax dispersion 4” was 50% by mass.

-Preparation of Aqueous Phase

838 parts of ion exchange water, 40 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 162 parts of an aqueous solution of sodium dodecyl diphenyl ether disulfonate (ELEMINOL MON-7 by Sanyo Chemical Industries Ltd., content of 50% by mass), 202 parts of an aqueous solution of carboxymethylcellulose (content of 1% by mass) as a thickener, and 108 parts of ethyl acetate were mixed and stirred together to obtain a milky liquid. This is referred to as “aqueous phase 4”.

-Emulsification-

To the total amount of “pigment/wax dispersion 4”, 1.29 parts of isohorone diamine as an amine was added and mixed in a TK homomixer by Tokushu Kika Kogyo Co., Ltd. at 5,000 rpm for 1 minute. Then 88.7 parts of “prepolymer 1” was added and mixed in a TK homomixer by Tokushu Kika Kogyo Co., Ltd. at 5,000 rpm for 1 minute, and 1,340 parts of “aqueous phase 4” was added and mixed in a TK homomixer for 20 minutes while adjusting the rotation speed between 8,000 rpm to 13,000 rpm to obtain “emulsion slurry 4”.

Thereafter, procedures of Example 1 were repeated to prepare “developer 4K”, “developer 4Y”, “developer 4M”, and “developer 4C”.

### Example 5

-Preparation of Pigment/Wax Dispersion (Oil Phase)-

126 parts of “polyester 1”, 42 parts of paraffin wax (melting point: 72° C.) and 438 parts of ethyl acetate were introduced into a vessel provided with stirrer and thermometer, and the temperature was raised to 80° C. with stirring, maintained at 80° C. for 5 hours, and cooled to 30° C. over 1 hour. Next, 137 parts of“masterbatch K” was added to the vessel and mixed for 1 hour. The mixture was transferred to another vessel, and pigment and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes to obtain “raw material solution 5”. Next, to 372 parts of “raw material solution 5”, 184 parts of 70% by mass ethyl acetate solution of the “polyester 1” and 253 parts of dispersion of “vinyl resin 1” dissolved in 50% by mass ethyl acetate were added and stirred with Three-One Motor for 2 hours to obtain “pigment/wax dispersion 5”. Ethyl acetate was added to adjust the concentration so that a solid content, measured at 130° C., 30 minutes, of the “pigment/wax dispersion 5” was 50% by mass.

-Preparation of Aqueous Phase

838 parts of ion exchange water, 40 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 162 parts of an aqueous solution of sodium dodecyl diphenyl ether disulfonate (ELEMINOL MON-7 by Sanyo Chemical Industries Ltd., content of 50% by mass), 202 parts of an aqueous solution of carboxymethylcellulose (content of 1% by mass) as a thickener, and 108 parts of ethyl acetate were mixed and stirred together to obtain a milky liquid. This is referred to as “aqueous phase 5”.

-Emulsification-

To the total amount of “pigment/wax dispersion 5”, 1.19 parts of isohorone diamine as an amine was added and mixed in a TK homomixer by Tokushu Kika Kogyo Co., Ltd. at 5,000 rpm for 1 minute. Then 82.4 parts of “prepolymer 1” was added and mixed in a TK homomixer by Tokushu Kika Kogyo Co., Ltd. at 5,000 rpm for 1 minute, and 1,340 parts of “aqueous phase 4” was added and mixed in a TK homomixer for 20 minutes while adjusting the rotation speed between 8,000 rpm to 13,000 rpm to obtain “emulsion slurry 4”.

Thereafter, procedures of Example 1 were repeated to prepare “developer 5K”, “developer 5Y”, “developer 5M”, and “developer 5C”.

### Example 6

“Developer 6K”, “developer 6Y”, “developer 6M”, and “developer 6C” were prepared in the same way as in Example 5, except that the dispersion of “vinyl resin 1” dissolved in 50% by mass ethyl acetate was changed to a dispersion of “vinyl resin 2” dissolved in 50% by mass ethyl acetate.

### Example 7

“Developer 7K”, “developer 7Y”, “developer 7M”, and “developer 7C” were prepared in the same way as in Example 3, except that the dispersion of “vinyl resin 2” dissolved in 50% by mass ethyl acetate was changed to a dispersion of “vinyl resin 3” dissolved in 50% by mass ethyl acetate.

### Example 8

“Developer 8K”, “developer 8Y”, “developer 8M”, and “developer 8C” were prepared in the same way as in Example 3, except that the dispersion of “vinyl resin 2” dissolved in 50% by mass ethyl acetate was changed to a dispersion of “vinyl resin 4” dissolved in 50% by mass ethyl acetate.

### Example 9

“Developer 9K”, “developer 9Y”, “developer 9M”, and “developer 9C” were prepared in the same way as in Example 3, except that the dispersion of “vinyl resin 2” dissolved in 50% by mass ethyl acetate was changed to a dispersion of “vinyl resin 5” dissolved in 50% by mass ethyl acetate.

### Comparative Example 1

-Preparation of Pigment/Wax Dispersion (Oil Phase)-

126 parts of “polyester 1”, 42 parts of paraffin wax (melting point: 72° C.) and 438 parts of ethyl acetate were introduced into a vessel provided with stirrer and thermometer, and the temperature was raised to 80° C. with stirring, maintained at 80° C. for 5 hours, and cooled to 30° C. over 1 hour. Next, 137 parts of “masterbatch K” was added to the vessel and mixed for 1 hour. The mixture was transferred to another vessel, and pigment and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes to obtain “raw material solution R1”. Next, to 372 parts of “raw material solution R1”, 424 parts of 70% by mass ethyl acetate solution of the “polyester 1” was added and stirred with Three-One Motor for 2 hours to obtain “pigment/wax dispersion R1”. Ethyl acetate was added to adjust the concentration so that a solid content, measured at 130° C., 30 minutes, of the “pigment/wax dispersion R1” was 50% by mass.

-Preparation of Aqueous Phase

838 parts of ion exchange water, 40 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 162 parts of an aqueous solution of sodium dodecyl diphenyl ether disulfonate (ELEMINOL MON-7 by Sanyo Chemical Industries Ltd., content of 50% by mass), 202 parts of an aqueous solution of carboxymethylcellulose (content of 1% by mass) as a thickener, and 108 parts of ethyl acetate were mixed and stirred together to obtain a milky liquid. This is referred to as “aqueous phase R1”.

-Emulsification-

To the total amount of “pigment/wax dispersion R1”, 1.5 parts of isohorone diamine as an amine was added and mixed in a TK homomixer by Tokushu Kika Kogyo Co., Ltd. at 5,000 rpm for 1 minute. Then 1,340 parts of “aqueous phase R1” was added and mixed in a TK homomixer for 20 minutes while adjusting the rotation speed between 8,000 rpm to 13,000 rpm to obtain “emulsion slurry R1”.

Thereafter, procedures of Example 1 were repeated to prepare “developer R1K”, “developer R1Y”, “developer R1M”, and “developer R1C”.

### Comparative Example 2

-Preparation of Pigment/Wax Dispersion (Oil Phase)-

126 parts of “polyester 1”, 42 parts of paraffin wax (melting point: 72° C.) and 438 parts of ethyl acetate were introduced into a vessel provided with stirrer and thermometer, and the temperature was raised to 80° C. with stirring, maintained at 80° C. for 5 hours, and cooled to 30° C. over 1 hour. Next, 137 parts of“masterbatch K” was added to the vessel and mixed for 1 hour. The mixture was transferred to another vessel, and pigment and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes to obtain “raw material solution R2”. Next, to 372 parts of “raw material solution R2”, 338 parts of 70% by mass ethyl acetate solution of the “polyester 1” was added and stirred with Three-One Motor for 2 hours to obtain “pigment/wax dispersion R2”. Ethyl acetate was added to adjust the concentration so that a solid content, measured at 130° C., 30 minutes, of the “pigment/wax dispersion R2” was 50% by mass.

-Preparation of Aqueous Phase

838 parts of ion exchange water, 40 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 162 parts of an aqueous solution of sodium dodecyl diphenyl ether disulfonate (ELEMINOL MON-7 by Sanyo Chemical Industries Ltd., content of 50% by mass), 202 parts of an aqueous solution of carboxymethylcellulose (content of 1% by mass) as a thickener, and 108 parts of ethyl acetate were mixed and stirred together to obtain a milky liquid. This is referred to as “aqueous phase R2”.

-Emulsification-

To the total amount of “pigment/wax dispersion R2”, 1.75 parts of isohorone diamine as an amine was added and mixed in a TK homomixer by Tokushu Kika Kogyo Co., Ltd. at 5,000 rpm for 1 minute. Then 120 parts of “prepolymer 1” was added and mixed in a TK homomixer by Tokushu Kika Kogyo Co., Ltd. at 5,000 rpm for 1 minute, and 1,340 parts of “aqueous phase R2” was added and mixed in a TK homomixer for 20 minutes while adjusting the rotation speed between 8,000 rpm to 13,000 rpm to obtain “emulsion slurry R2”.

Thereafter, procedures of Example 1 were repeated to prepare “developer 2K”, “developer 2Y”, “developer 2M”, and “developer 2C”.

### Reference Example 1

“Developer R3K”, “developer R3Y”, “developer R3M”, and “developer R3C” were prepared in the same way as in Example 3, except that, in Example 3, the dispersion of “vinyl resin 2” dissolved in 50% by mass ethyl acetate was changed to a dispersion of “vinyl resin 6” dissolved in 50% by mass ethyl acetate.

### Comparative Example 3

It was attempted to prepare a toner in the same way as in Example 3, except that, in Example 3, the dispersion of “vinyl resin 2” dissolved in 50% by mass ethyl acetate was changed to a dispersion of “vinyl resin 7” dissolved in 50% by mass ethyl acetate, but it was not possible because fine powder was generated in large amount during granulation.

### Reference Example 2

“Developer R5K”, “developer R5Y”, “developer R5M”, and “developer R5C” were prepared in the same way as in Example 3, except that, in Example 3, the dispersion of “vinyl resin 2” dissolved in 50% by mass ethyl acetate was changed to a dispersion of “vinyl resin 8” dissolved in 50% by mass ethyl acetate.

### Reference Example 3

-Preparation of Pigment/Wax Dispersion (Oil Phase)-

126 parts of “polyester 1”, 42 parts of paraffin wax (melting point: 72° C.) and 438 parts of ethyl acetate were introduced into a vessel provided with stirrer and thermometer, and the temperature was raised to 80° C. with stirring, maintained at 80° C. for 5 hours, and cooled to 30° C. over 1 hour. Next, 137 parts of“masterbatch K” was added to the vessel and mixed for 1 hour. The mixture was transferred to another vessel, and pigment and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes to obtain “raw material solution R6”. Next, to 372 parts of “raw material solution R6”, 312 parts of 70% by mass ethyl acetate solution of the “polyester 1” and 42.5 parts of dispersion of “vinyl resin 1” dissolved in 50% by mass ethyl acetate were added and stirred with Three-One Motor for 2 hours to obtain “pigment/wax dispersion R6”. Ethyl acetate was added to adjust the concentration so that a solid content, measured at 130° C., 30 minutes, of the “pigment/wax dispersion R6” was 50% by mass.

-Preparation of Aqueous Phase

838 parts of ion exchange water, 40 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 162 parts of an aqueous solution of sodium dodecyl diphenyl ether disulfonate (ELEMINOL MON-7 by Sanyo Chemical Industries Ltd., content of 50% by mass), 202 parts of an aqueous solution of carboxymethylcellulose (content of 1% by mass) as a thickener, and 108 parts of ethyl acetate were mixed and stirred together to obtain a milky liquid. This is referred to as “aqueous phase R6”.

-Emulsification-

To the total amount of “pigment/wax dispersion R6”, 1.65 parts of isohorone diamine as an amine was added and mixed in a TK homomixer by Tokushu Kika Kogyo Co., Ltd. at 5,000 rpm for 1 minute. Then 114 parts of“prepolymer 1” was added and mixed in a TK homomixer by Tokushu Kika Kogyo Co., Ltd. at 5,000 rpm for 1 minute, and 1,340 parts of “aqueous phase R6” was added and mixed in a TK homomixer for 20 minutes while adjusting the rotation speed between 8,000 rpm to 13,000 rpm to prepare “emulsion slurry R6”.

Thereafter, procedures of Example 1 were repeated to prepare “developer 6K”, “developer 6Y”, “developer 6M”, and “developer 6C”.

For each developer obtained, the infrared absorption spectrum was measured in the following manner. The results are shown in Table 2. In addition, for each developer, various performances were evaluated in the following manner. The results are shown in Table 3.

<Measurement of Infrared Absorption Spectrum>

The infrared absorption spectrum of developer was measured by FT-IR method. Specifically, to powder KBr for the measurement of infrared absorption spectrum, 1% by mass of developer was added and ground well with a pestle and mortar, an appropriate amount of which was packed into a sample holder. A pressure was applied to prepare a sample. Measurement was performed by scanning from 4,000 cm⁻¹ to 450 cm⁻¹ 16 times. For background measurement, KBr was used. Peak absorbances I1 and I2 were determined as follows. First, the peak height near 730 cm⁻¹ from the baseline connecting bottoms on the both sides (about 743 cm⁻¹ and about 710 cm⁻¹) of the peak near 730 cm⁻¹ was defined as I1. Likewise, the peak height near 700 cm⁻¹ from the baseline connecting bottoms on the both sides (about 710 cm⁻¹ and about 690 cm⁻¹) of the peak near 700 cm⁻¹ was defined as 12. In the FT-ATR-IR method, 3g of developer was placed in a mold with a 4 cm diameter, a force of 6 MPa was applied to the entire mold for 30 seconds. Using the pressure molded or formed sample, the surface was measured. Air was used as the background. The peak absorbances, A1 and A2 were determined in the same way as in the FT-IR method. The apparatuses used for the measurement were as follows.

Main body of apparatus (used for both FT-IR and FT-ATR-IR): Spectrum One FT-IR Spectrometer by PerkinElmer, Inc.

Microscope part during the FT-ATR-IR measurement: Auto IMAGE FT-IR Microscope by PerkinElmer, Inc. * Internal reflection element (IRE) for FT-ATR-IR: Ge (germanium)

<Evaluation of Fixability>

A toner including external additives (developer) was set in an image forming apparatus (IPSiO CX2500 by Ricoh Company, Ltd.). Unfixed 36 mm-wide solid images (toner adhesive amount: 9 g/m²) were formed on the A4 size paper, fed in portrait direction, at a position of 3 mm behind the tip thereof. The unfixed images were fixed using a fixing device described below at a temperature of from 130° C. to 190° C. in 10° C. steps, and a separable/non-offset temperature range was determined. The separable/non-offset temperature range as used herein refers to a fixable temperature range in which the paper is separated from a heating roller properly, offset phenomenon does not occur, and images are not easily peeled off. The paper used for the evaluation had a weight of 45 g/m² and had a cross direction, and the paper was fed in portrait direction, which is disadvantage for the paper separation. The fixing device had a circumferential speed of 120 mm/sec.

FIG. 2 illustrates a fixing device that includes soft rollers having a fluorinated surface layer. Specifically, a heating roller 11 has an outside diameter of 40 mm and includes: an aluminum cored bar 13; an elastic layer 14 thereon; and a surface layer 15 that comprises tetrafluoroethylene-perfluoroalkyl vinylether copolymer (PFA surface layer); and a heater 16 inside the aluminum cored bar, wherein the elastic layer 14 is made of silicone rubber and has a thickness of 1.5 mm. A pressure roller 12 has an outside diameter of 40 mm and includes: an aluminum cored bar 17; an elastic layer 18 thereon; and a PFA surface layer 19, wherein the elastic layer 18 is made of silicone rubber and has a thickness of 1.5 mm. A paper 21 having an unfixed image 20 thereon is fed as shown in FIG. 2.

[Evaluation Standards]

A: separable/non-offset temperature range was 50° C. or more

B: separable/non-offset temperature range was 30° C. or more and less than 50° C.

C: separable/non-offset temperature range was less than 30° C.

<Evaluation of Filming Property>

A toner including external additives (developer) was set in an image forming apparatus (IPSiO CX2500 by Ricoh Company, Ltd.). A predetermined print pattern with a B/W ratio of 6% was continuously printed under the N/N environment (23° C., 45% RH). After continuous printing of 2,000 sheets (continuous running) under the N/N environment, a photoconductor and an intermediate transfer belt were observed with eyes and evaluated. The evaluation was performed as follows.

[Evaluation Standards]

A: The filming was not observed on the photoconductor and intermediate transferring member, having no problem.

B: The filming was observed on either the photoconductor or intermediate transferring member, but not found on the produced image, having no problem in practical use

C: The filming was observed on the photoconductor and/or intermediate transferring member, and also found on the produced image, having problem in practical use

<Evaluation of Stress Resistance>

A toner including external additives (developer) was set in an image forming apparatus (IPSiO CX2500 by Ricoh Company, Ltd.). A predetermined print pattern with a B/W ratio of 6% was continuously printed under the N/N environment (23° C., 45% RH). After continuous printing of 50 sheets and 2,000 sheets (continuous running) under the N/N environment, the toner on a developing roller was aspirated while copies having no image were produced, and charge amount was measured with an electrometer. The difference of the amount of charge after 50 copies and after 2,000 copies was evaluated.

[Evaluation Standards]

A: absolute value of the difference of the amount of charge is less than 10 μC/g

B: absolute value of the difference of the amount of charge is from 10 μC/g to 15 μC/g.

C: absolute value of the difference of the amount of charge is more than 10 μC/g

<Evaluation of Anti-heat Preservability>

A toner was stored for 8 hours at 50° C., followed by sieving with a sieve of 42 mesh for 2 minutes. The residual ratio of the toner on the screen was used as an indicator of anti-heat preservability. The anti-heat preservability was evaluated on the following four levels.

[Evaluation Standards]

D: more than 30%

C: from 20% to 30%

B: from 10% to 20%

A: less than 10%

<Environmental Resistance>

Toners of Y, M, C and K including external additives (developers) were each set in an image forming apparatus (IPSiO CX2500 by Ricoh Company, Ltd.). For each toner, a predetermined print pattern with a B/W ratio of 6% was continuously printed under the H/H environment (28° C., 80% RH) and L/L environment (10° C., 15% RH). After continuous printing of 50 sheets and 2,000 sheets (continuous running), a transparent tape was attached to the photoconductor while copies having no image were produced, and then peeled off. The tape was attached to a white paper so as to be measured L* value by a spectrometer. The results were evaluated as a background smear. The standard value is L*=90 or more.

[Evaluation Standards]

A: Both L*s after 50 copies and 2,000 copies exceeds the standard value.

B: L* after 50 copies exceeds the standard value, but L* after is 2,000 copies is less than the standard value

C: Both L*s after 50 copies and 2,000 copies is less than the standard value

TABLE 2

| | FT-IR Method | | | FT-ATR-IR Method | | |
|---|---|---|---|---|---|---|
| | | | Intensity | | | Intensity |
| | Peak Intensity | | Ratio | Peak Intensity | | Ratio |
| | I1 | I2 | RI | A1 | A2 | RA |
| Example 1 | 0.118 | 0.355 | 0.332 | 0.0537 | 0.132 | 0.407 |
| Example 2 | 0.205 | 0.343 | 0.598 | 0.0894 | 0.114 | 0.784 |
| Example 3 | 0.211 | 0.347 | 0.608 | 0.101 | 0.116 | 0.871 |
| Example 4 | 0.314 | 0.325 | 0.966 | 0.171 | 0.0921 | 1.857 |
| Example 5 | 0.298 | 0.315 | 0.946 | 0.132 | 0.0935 | 1.412 |
| Example 6 | 0.387 | 0.319 | 1.213 | 0.192 | 0.0967 | 1.986 |
| Example 7 | 0.201 | 0.350 | 0.574 | 0.112 | 0.124 | 0.903 |
| Example 8 | 0.163 | 0.358 | 0.455 | 0.0786 | 0.114 | 0.689 |
| Example 9 | 0.137 | 0.334 | 0.410 | 0.0629 | 0.109 | 0.577 |
| Comp. | 0.0757 | 0.362 | 0.209 | 0.0064 | 0.139 | 0.046 |
| Example 1 | | | | | | |
| Comp. | 0.0724 | 0.353 | 0.205 | 0.0088 | 0.135 | 0.065 |
| Example 2 | | | | | | |
| Comp. | — | — | — | — | — | — |
| Example 3 | | | | | | |
| Ref. | 0.218 | 0.351 | 0.621 | 0.0998 | 0.112 | 0.891 |
| Example 1 | | | | | | |
| Ref. | 0.177 | 0.361 | 0.490 | 0.0802 | 0.118 | 0.680 |
| Example 2 | | | | | | |
| Ref. | 0.0892 | 0.359 | 0.248 | 0.0349 | 0.129 | 0.271 |
| Example 3 | | | | | | |

TABLE 3

| | Resin Composition | | | | | | | | | | | |
|---|---|---|---|---|---|---|---|---|---|---|---|---|
| | Toner or Core Part | | | | | | | | | | | |
| | | Vinyl Resin | | | | | | Evaluation | | | | |
| | Polyester | | % by | Toner Particle Diameter | | | Shape | | | Stress | Environmental | Anti-heat |
| | Resin | Type | mass | Dv | Dn | Dv/Dn | Circularity | Fixability | Filming | Resistance | Resistance | Preservability |
| Example 1 | P-1 + HP | V-1 | 10 | 6.2 | 5.5 | 1.13 | 0.973 | A | A | A | A | A |
| Example 2 | P-1 + HP | V-1 | 20 | 6.1 | 5.4 | 1.13 | 0.971 | A | A | A | A | A |
| Example 3 | P-1 + HP | V-2 | 15 | 5.7 | 5.1 | 1.12 | 0.974 | A | A | A | A | A |
| Example 4 | P-1 + HP | V-2 | 25 | 5.8 | 5.2 | 1.12 | 0.970 | A | A | A | A | A |
| Example 5 | P-1 + HP | V-1 | 30 | 5.9 | 5.2 | 1.13 | 0.974 | A | A | A | A | A |
| Example 6 | P-1 + HP | V-2 | 30 | 5.7 | 5.2 | 1.10 | 0.975 | A | A | A | A | A |
| Example 7 | P-1 + HP | V-3 | 15 | 5.9 | 5.1 | 1.16 | 0.972 | A | A | A | A | A |
| Example 8 | P-1 + HP | V-4 | 15 | 6.3 | 5.5 | 1.15 | 0.971 | A | A | A | A | A |
| Example 9 | P-1 + HP | V-5 | 15 | 6.2 | 5.3 | 1.17 | 0.973 | A | A | A | A | A |
| Comp. Example 1 | P-1 | — | — | 5.6 | 5.0 | 1.12 | 0.974 | C | C | C | B | D |
| Comp. Example 2 | P-1 + HP | — | — | 5.9 | 5.3 | 1.11 | 0.971 | B | B | A | A | A |
| Comp. Example 3 | P-1 + HP | V-7 | 15 | — | — | — | — | — | — | — | — | — |
| Ref. Example 1 | P-1 + HP | V-6 | 15 | 5.5 | 4.8 | 1.15 | 0.978 | B | A | A | C | B |
| Ref. Example 2 | P-1 + HP | V-8 | 15 | 6.0 | 5.2 | 1.15 | 0.977 | A | C | C | B | D |
| Ref. Example 3 | P-1 + HP | V-1 | 5 | 5.9 | 5.2 | 1.13 | 0.975 | B | B | A | B | B |

As shown in the results in Tables 2 and 3, in the case of the toners of Examples 1 to 9, extremely satisfactory results were obtained.

In contrast, in the case of the toners of Comparative Examples 1 and 2, in which the vinyl resin is not present near the surface results of fixability (both of fixing at low temperatures and anti-hot offset), filming (exposure of releasing agent), stress resistance (exposure of pigment), and anti-heat preservability (blocking) were not satisfactory.

Also, Reference Example 3, similar results were obtained because of insufficient amount of vinyl resin added.

Reference Example 1, background smear was caused during development possibly because vinyl resin V-6 with a too low acid value was used. Thus, satisfactory results were not obtained.

Reference Example 2, evaluation of anti-heat preservability or the like was bad. This is probably due to the use of vinyl resin V-8 with a low glass transition temperature (Tg).

### Synthetic Example 10

-Polyester Resin 2-

In a reaction vessel equipped with condenser tube, stirrer, and nitrogen inlet tube, 553 parts of bisphenol A ethyleneoxide dimole adduct, 196 parts of bisphenol A propylene oxide dimole adduct, 220 parts of terephthalic acid, 45 parts of adipic acid and 2 parts of dibutyl tin oxide were placed, and the reaction was performed under normal pressure at 230° C. for 8 hours. Further, the reaction was performed under a reduced pressure of 10 mmHg to 15 mmHg for 5 hours. Then, 46 parts of trimellitic anhydride was placed in the reaction vessel, and the reaction was performed under normal pressure at 180 ° C. for 2 hours to obtain “polyester resin 2”. The “polyester resin 2” had a number average molecular mass of 2,200, a mass average molecular mass of 5,600, a glass transition temperature (Tg) of 43° C., and an acid value of 13 mgKOH/g.

### Synthetic Example 11

-Synthesis of Polyester Resin P8- “Polyester resin P8” was synthesized in the same way as in Synthetic Example 10, except that the additive amounts of 350 parts of bisphenol A ethylene oxide dimole adduct, 200 parts of bisphenol A propylene oxide dimole adduct, and 120parts of trimellitic anhydride in the above-mentioned “polyester resin2” were adjusted so that the “polyester resin P8” had an acid value of 40. The “polyester resin P8” had a glass transition temperature (Tg) of 50° C., a number average molecular mass of 2,000, and a mass average molecular mass of 4,900.

### Synthetic Example 12

-Synthesis of Vinyl Copolymer Resin P1-

In a reaction vessel equipped with condenser tube, stirrer, and nitrogen inlet tube, 1.6 parts of sodium dodecyl sulfate and 492 parts of ion exchange water were placed, headed to 80° C., and then a solution of 2.5 parts of potassium persulfate (KPS) as a polymerization initiator dissolved in 100 parts of ion exchange water was added thereto. After 15 minutes, a mixture of 120 parts of styrene monomer, 51 parts of butyl acrylate, and 29 parts of methacrylic acid that are a composition of the monomers, and 4.1 parts of n-octyl mercaptan (NOM) as a molecular mass-adjusting agent was dropped thereto over 90 minutes and then kept at 80° C. for 60 minutes. After cooling down, obtained latex was dried by hot air at 40° C. and then dried under a reduced pressure at 40° C. to obtain “vinyl copolymer resin P1”. The “vinyl copolymer resin P1” had a mass average molecular mass of 12,500 and a glass transition temperature (Tg) of 50° C., and had an acid value of 100 mgKOH/g, calculated based on the composition of the monomers.

### Synthetic Examples 13 to 18

-Synthesis of vinyl copolymer resins P2 to P5, P7, and P9-

“Vinyl copolymer resins P2 to P5, P7, and P9” were synthesized in the same way as in Synthetic Example 12, except that the composition of the monomers were changed as described in Table 4.

### Synthetic Example 19

-Synthesis of Highly-polar Polyester Resin P6-

In a 10 l four-neck flask equipped with nitrogen inlet tube, dewatering conduit, stirrer, and thermocouple, 1,500 parts of 1,4-butanediol, 2,200 parts of fumaric acid, 400 parts of ethylene glycol, 250 parts of adipic acid, and 5.3 g of hydroquinone were placed, and the reaction was performed at 180° C. for 5 hours. Then the temperature was raised to 200° C. under a reduced pressure of 10 mmHg to 15 mmHg and the reaction was performed for 3 hours. 1,000 parts of trimellitic anhydride was added, and the reaction was performed under normal pressure for 3 hours to obtain “highly-polar polyester resin P6”. The “highly-polar polyester resin P6” had a number average molecular mass of 1,200, a mass average molecular mass of 3,200, and an acid value of 60 mgKOH/g.

The composition of the monomers and properties of vinyl copolymer resins P1 to P5, P7, and P9 are described in the list of produced resins of Table 4.

TABLE 4

| | | | | | | | | Mass | |
|---|---|---|---|---|---|---|---|---|---|
| | | | | | | | Acid Value | Average | |
| Resin | | Monomer Composition (mass ratio) | | | | | (mgKOH/g) | Molecular | Tg |
| Number | Type of Polymer | St | BA | MAA | SSA | MDU | (calcuated value) | Mass (Mw) | (° C.) |
| P1 | Vinyl Copolymer Resin | 60 | 25.5 | 14.5 | 0 | 0 | 100 | 12,500 | 50 |
| P2 | Vinyl Copolymer Resin | 50 | 28 | 22 | 0 | 0 | 150 | 12,100 | 52 |
| P3 | Vinyl Copolymer Resin | 67.3 | 24 | 8.7 | 0 | 0 | 60 | 11,000 | 48 |
| P4 | Vinyl Copolymer Resin | 43.2 | 27 | 29.8 | 0 | 0 | 200 | 13,200 | 58 |
| P5 | Vinyl Copolymer Resin | 67.7 | 18 | 0 | 14.3 | 0 | 50 | 12,800 | 54 |
| P6 | Polyester Resin | Described in the text | | | | | | | |
| P7 | Vinyl Copolymer Resin | 34.1 | 28.1 | 37.8 | 0 | 0 | 250 | 10,500 | 60 |
| P8 | Polyester Resin | Described in the text | | | | | | | |
| P9 | Vinyl Copolymer Resin | 42 | 12 | 20 | 0 | 26 | 160 | 13,800 | 51 |

Monomer Composition
St: Styrene
BA: Butyl acrylate
MAA: Methacrylic acid
SSA: 4-Styrenesulfonic acid
MDU: ω-Methacryloxydodecyl urea

### Synthetic Example 20

-Synthesis of Vinyl Copolymer Resin Particle Vl1-

In a reaction vessel equipped with condenser tube, stirrer, and nitrogen inlet tube, 1.6 parts of sodium dodecyl sulfate and 492 parts of ion exchange water were placed, headed to 80° C., and then a solution of 2.5 parts of potassium persulfate dissolved in 100 parts of ion exchange water was added thereto. After 15 minutes, a mixture of 60 parts of styrene, 20 parts of butyl acrylate, 20 parts of methacrylic acid, 100 parts of p-styryltrimethoxysilane, and 3.5 parts of n-octyl mercaptan was dropped thereto over 90 minutes and then kept at 80° C. for 60 minutes. Then, the mixture was cooled down to obtain a dispersion of “vinyl copolymer resin particle Vl”. The obtained “vinyl copolymer resin particle Vl” had an average particle diameter of 65 nm. A small amount of the dispersion was is placed in a Petri dish, the dispersion medium was evaporated, and the obtained solid was measured. The solid had a number average molecular mass of 11,000, a mass average molecular mass of 18,000, and a glass transition temperature (Tg) of 60° C.

Next, ion exchange water was poured in a 10 L vessel and using a regenerated cellulose dialysis tube (Spectra/Por, by Spectrum Laboratories, Inc., molecular weight cut off, 3,500; diameter, 34 mm), 200 g of water dispersion of “vinyl copolymer resin particle V1”was immersed in the 10 L vessel, from which the water overflowed, at room temperature for 24 hours. Then, resin particles were reprecipitated with 5 L ethanol and filtered to prepare 25% by mass of “ethyl acetate solution X1 of vinyl copolymer resin”.

### Synthetic Example 21

-Synthesis of Vinyl Copolymer Resin Particle- In a reaction vessel equipped with condenser tube, stirrer, and nitrogen inlet tube, 1.6 parts of sodium dodecyl sulfate and 492 parts of ion exchange water were placed, headed to 80° C., and then a solution of 2.5 parts of potassium persulfate dissolved in 100 parts of ion exchange water was added thereto. After 15 minutes, a mixture of 90 parts of styrene, parts of butyl acrylate, 20 parts of methacrylic acid, 90 parts of 3-methacryloyloxypropyltrimethoxysilane, and 3.5 parts of n-octyl mercaptan was dropped thereto over 90 minutes and kept at 80° C. for 60 minutes. Then, the mixture was cooled down to obtain a dispersion of “vinyl copolymer resin particle V2”. The obtained “vinyl copolymer resin particle V2” had an average particle diameter of 70 nm. A small amount of the dispersion was placed in a Petri dish, the dispersion medium was evaporated, and the obtained solid was measured. The solid had a number average molecular mass of 9,000, a mass average molecular mass of 15,000, and a glass transition temperature (Tg) of 50° C.

Next, ion exchange water was poured in a 10 L vessel and using a regenerated cellulose dialysis tube (Spectra/Por, by Spectrum Laboratories, Inc., molecular weight cut off, 3,500; diameter, 34 mm), 200 g of water dispersion of “vinyl copolymer resin particle V2” was immersed in the 10 L vessel, from which the water overflowed, at room temperature for 24 hours. Then, resin particles were reprecipitated with 5 L ethanol and filtered to prepare 25% by mass of “ethyl acetate solution X2 of vinyl copolymer resin”.

### Example 10

-Production of Prepolymer-

In a reaction vessel equipped with condenser tube, stirrer, and nitrogen inlet tube, 682 parts of bisphenol A ethyleneoxide dimole adduct, 81 parts of bisphenol A propylene oxide dimole adduct, 283 parts of terephthalic acid, 22 parts of trimellitic anhydride and 2 parts of dibutyl tin oxide were placed, and the reaction was performed under normal pressure at 230° C. for 8 hours. Further, the reaction was performed under a reduced pressure of 10 mmHg to 15 mmHg for 5 hours to prepare “intermediate polyester”. The obtained “intermediate polyester” had a number average molecular mass of 2,100, a mass average molecular mass of 9,500, a glass transition temperature (Tg) of 55° C., an acid value of 0.5 mgKOH/g, and a hydroxyl value of 49 mgKOH/g.

Next, in a reaction vessel equipped with condenser tube, stirrer, and nitrogen inlet tube, 411 parts of “intermediate polyester”, 89 parts of isophorone diisocyanate and 500 parts of ethyl acetate were placed. The reaction was performed at 100° C. for 5 hours to prepare “prepolymer”. The content of free isocyanate in the obtained “prepolymer” was 1.53% by mass.

-Preparation of Masterbatch-

40 parts of carbon black (REGAL 400R by Cabot Corporation), 60 parts of polyester resin (RS801 by Sanyo Chemical Industries, Ltd., acid value: 10 mgKOH/g, mass average molecular mass (Mw): 20,000, glass transition temperature (Tg): 64° C.), and 30 parts of water were mixed with HENSCHEL MIXER to obtain a mixture in which water was infiltrated into a pigment aggregate. Then the mixture was kneaded for 45 minutes using two rollers, the surface temperature of which was set to 130° C., and crushed into particles having a size of 1 mm in diameter with a pulverizer to prepare “masterbatch”.

-Preparation of Pigment/Wax Dispersion (Oil Phase)-

378 parts of “polyester resin 2”, 120 parts of paraffin wax (HNP9 by Nippon Seiro Co., Ltd.) and 1450 parts of ethyl acetate were introduced into a vessel provided with stirrer and thermometer, and the temperature was raised to 80° C. with stirring, maintained at 80° C. for 5 hours, and cooled to 30° C. over 1 hour. Next, 500 parts of “masterbatch” and 500 parts of ethyl acetate were introduced into a vessel and mixed for 1 hour to obtain “raw material solution”.

1,500 parts of “raw material solution” was transferred to another vessel, and carbon black and wax were dispersed using a bead mill (Ultra Visco Mill by Aimex Co., Ltd.) under the condition of liquid feed rate 1 kg/hr, disk circumferential speed 6 m/sec, 0.5 mm zirconia beads packed to 80% by volume and 3 passes. Next, 655 parts of 65% by mass ethyl acetate solution of the “polyester resin 2” was added, and the mixture was dispersed using the bead mill under the same condition as mentioned above except that the dispersion operation was performed once to thereby obtain “pigment/wax dispersion 1”. Ethyl acetate was added to adjust the concentration so that a solid content, measured at 130° C., 30 minutes, of the “pigment/wax dispersion 1” was 50% by mass.

-Preparation of Aqueous Phase

953 parts of ion exchange water, 88 parts of an aqueous dispersion of organic resin fine particles (styrene/methacrylic acid/butyl acrylate/sodium salt of a sulfuric acid ester of ethylene oxide adduct of methacrylic acid copolymer, content of 25% by mass) for stabilizing a dispersion, 90 parts of 48.5% aqueous solution of sodium dodecyl diphenyl ether disulfonate (ELEMINOL MON-7 by Sanyo Chemical Industries Ltd.), and 113 parts of ethyl acetate were mixed and stirred together to obtain a milky liquid. This is referred to as “aqueous phase”.

-Emulsification-

To 967 parts of “pigment/wax dispersion”, 10% by mass of the resin P1 listed in Table 5 and 6 parts of isohorone diamine as an amine were added and mixed in a TK homomixer by Tokushu Kika Kogyo Co., Ltd. at 5,000 rpm for 1 minute. Then 137 parts of “prepolymer” was added and mixed in a TK homomixer by Tokushu Kika Kogyo Co., Ltd. at 5,000 rpm for 1 minute, and 1,200 parts of “aqueous phase” was added and mixed in a TK homomixer for 20 minutes while adjusting the rotation speed between 8,000 rpm to 13,000 rpm to obtain “emulsion slurry”.

-Removal of Solvent-

The “emulsion slurry” was placed in a vessel equipped with stirrer and thermometer, and the solvent was removed at 30° C. for 8 hours to obtain “dispersion slurry”.

-Washing and Drying-

100 parts of “dispersion slurry” was filtered under the reduced pressure, then

(1) 100 parts of ion exchange water were added to the filter cake and mixed in a TK homomixer at a rotation speed of 12,000 rpm for 10 minutes and filtered.

(2) 900 parts of ion exchange water were added to the filter cake of (1), mixed for 30 minutes in a TK homomixer at a rotation speed of 12,000 rpm with applying an ultrasonic wave and then filtered under the reduced pressure. This operation was repeated until an electric conductivity of reslurry solution was not greater than 10 μC/cm.

(3) 10% by mass hydrochloric acid was added to the reslurry solution of the filter cake of (2) so that pH of the reslurry solution was 4, stirred with Three-One Motor for 30 minutes, and then filtered.

(4) 100 parts of ion exchange water were added to the filter cake of (3), mixed in a TK homomixer at a rotation speed of 12,000 rpm for 10 minutes, and then filtered. This operation was repeated until an electric conductivity of reslurry solution was not greater than 10 μC/cm to obtain “filter cake”.

The “filter cake” was dried in a circulating air dryer at 45° C. for 48 hours, and sieved through a sieve of 75 μm mesh to obtain “toner-base particle”.

The obtained toner-base particle had a volume average particle diameter (Dv) of 5.8 μm, a number average particle diameter (Dn) of 5.2 μm, a Dv/Dn of 1.12, and an average circularity of 0.973.

Next, to 100 parts of the toner-base particle 0.5 parts of hydrophobized silica and 0.5 parts of hydrophobized titanium oxide were mixed in HENSCHEL MIXER to prepare “developer 10”.

### Examples 11 to 19

“Developers 11 to 19” of Examples 11 to 19 were prepared in the same way as in Example 10 except that, in Example 10, the type and amount of resin and wax were changed as shown in Table 5.

### Comparative Examples 4 to 6

“Developers R4 to R6” of Comparative Examples 4 to 6 were prepared in the same way as in Example 10 except that, in Example 10, the type and amount of resin and wax were changed as shown in Table 5.

TABLE 5

| | Resin | | | Wax | |
|---|---|---|---|---|---|
| | | Amount (% by mass | | | Amount (% by mass |
| | | relative to solid | Acid Value | | relative to solid |
| | Type | content of toner) | (mgKOH/g) | Type | content of toner) |
| Example 10 | P1 | 10 | 100 | W1 | 4 |
| Example 11 | P1 | 10 | 100 | W1 | 6 |
| Example 12 | P2 | 10 | 150 | W1 | 4 |
| Example 13 | P3 | 10 | 60 | W1 | 4 |
| Example 14 | P4 | 8 | 200 | W2 | 6 |
| Example 15 | P5 | 6 | 50 | W3 | 6 |
| Example 16 | P1 | 4 | 100 | W4 | 4 |
| Example 17 | P1 | 2 | 100 | W4 | 4 |
| Example 18 | P1 | 1 | 100 | W4 | 3 |
| Example 19 | P9 | 4 | 150 | W1 | 4 |
| Comp. | — | None | — | W1 | 6 |
| Example 4 | | | | | |
| Comp. | — | None | — | W1 | 2 |
| Example 5 | | | | | |
| Comp. | P8 | 10 | 40 | W1 | 6 |
| Example 6 | | | | | |

*W1: Paraffin wax (HNP9 by Nippon Seiro Co., Ltd.)
*W2: Trimethylolpropane tribehenate
*W3: Polyethylene wax (Polywax 400 by Baker-Petrolite)
*W4: Carnauva wax
*W5: Mixture of W1 + W2 (1:1)
*W6: Mixture of W1 + W4 (1:2)

### Example 20

10 “Developer 20” was prepared in the same way as in Example 10, except that in the emulsification of Example 10, 25% by mass of “ethyl acetate solution X1 of vinyl copolymer resin” was added so as to be 10% by mass in terms of solid content of toner.

The “Developer 20” had a volume average particle diameter (Dv) of 7.0 μm, a number average particle diameter (Dp) of 5.9 μm, a Dv/Dp of 1.19, and an average circularity of 0.978.

### Example 21

“Developer 21” was prepared in the same way as in Example 10, except that in the emulsification of Example 10, 25% by mass of “ethyl acetate solution X2 of vinyl copolymer resin” was added so as to be 10% by mass in terms of solid content of toner.

The “Developer 21” had a volume average particle diameter (Dv) of 7.5 μm, a number average particle diameter (Dp) of 6.4 μm, a Dv/Dp of 1.17, and an average circularity of 0.976.

Next, the thus-obtained developers of Examples 10 to 21 and Comparative Examples 4 to 6 were evaluated with respect to fixability, filming property, stress resistance, and anti-heat preservability in the same way as in Examples 1 to 9 and Comparative Examples 1 to 3. In addition, ATR value was measured, and background smear was evaluated. The results are shown in Table 6.

<Measurement of ATR value>Using FTIR-ATR method, a peak [A] between 850 cm⁻¹ and 783 cm⁻¹, derived from an aromatic group-containing polyester skeleton, and a peak [B] between 2834 cm⁻¹ and 2862 cm⁻¹, derived from a long-chain alkyl group of wax, were determined. Then, the ratio, [B]/[A], was calculated.

<Evaluation of Background Smear>

A toner including external additives (developer) was set in an image forming apparatus (IPSiO CX2500 by Ricoh Company, Ltd.). A predetermined print pattern with a B/W ratio of 6% was continuously printed under the N/N environment (23° C., 45% RH). After continuous printing of 50 sheets and 2,000 sheets (continuous running) under the N/N environment, a colorless, transparent tape was attached to the uncleaned portion of the photoconductor after development. The toner on the photoconductor that causes background smear was peeled off and attached to a white paper, and the density was observed with eyes. The evaluation was performed based on the following standards.

[Evaluation Standards]

A: No smear

B: Slight smear, but not significant

C: Noticeable smear

TABLE 6

| | | | Filming | Stress | Background | Anti-heat |
|---|---|---|---|---|---|---|
| | ATR value | Fixability | Property | Resistance | Smear | Preservability |
| Example 10 | 0.028 | A | A | A | A | A |
| Example 11 | 0.04 | A | A | B | A | A |
| Example 12 | 0.022 | A | A | A | A | A |
| Example 13 | 0.032 | A | A | A | A | A |
| Example 14 | 0.088 | A | A | A | A | A |
| Example 15 | 0.092 | A | B | A | B | B |
| Example 16 | 0.082 | A | A | A | A | A |
| Example 17 | 0.098 | A | B | A | B | B |
| Example 18 | 0.098 | A | B | A | B | B |
| Example 19 | 0.04 | A | A | A | A | A |
| Example 20 | 0.015 | B | A | A | A | A |
| Example 21 | 0.026 | A | A | A | A | B |
| Comp. Example 4 | 0.4 | A | C | C | C | D |
| Comp. Example 5 | 0.14 | B | C | C | C | D |
| Comp. Example 6 | 0.2 | A | C | C | C | D |

As shown in the results of Table 6, in the case of the developers of Examples 10 to 21 extremely satisfactory results were obtained in every performance relevant to the electrophotographic process. In contrast, in the cases of the developers of Comparative Examples 4 to 6, satisfactory results were not obtained in any of filming, stress resistance, background smear, and anti-heat preservability.

What is claimed is:

1. A toner, which is obtained by:
at least one of dissolving and dispersing at least a polyester resin, a vinyl resin, a releasing agent, and a colorant in an organic solvent,
wherein the polyester resin comprises a functional group-containing modified polyester resin capable of undergoing at least one of an elongation reaction and a crosslinking reaction with an active hydrogen group-containing compound;
then at least one of emulsifying and dispersing at least one of the dissolved solution and the dispersed solution in an aqueous medium to prepare an emulsified dispersion; and
allowing the functional group-containing modified polyester resin to undergo at least one of an elongation reaction and a crosslinking reaction with the active hydrogen group-containing compound in the aqueous medium,
wherein the vinyl resin is concentrated near the surface of the toner.

2. The toner according to claim 1, wherein an acid value of the vinyl resin is from 20 mgKOH/g to 250 mgKOH/g.

3. The toner according to claim 2, wherein the acid value of the vinyl resin is from 50 mgKOH/g to 250 mgKOH/g.

4. The toner according to claim 1, wherein the vinyl resin comprises a resin having in a side chain thereof a functional group selected from —OH, —COOH, —CONR¹R^{2,} and —NHCONR³R⁴ where R¹, R², R³, and R⁴ independently represent a hydrocarbon group having a carbon number of 1 to 8.

5. The toner according to claim 1, wherein the vinyl resin comprises a resin having a silanol group.

6. The toner according to claim 5, wherein the silanol group is obtained by subjecting a functional group expressed by the following general formula to chemical treatment: 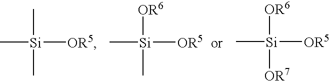
where, in the general formula, R⁵, R⁶, and R⁷ independently represent any one of a branched or straight-chain alkyl group having a carbon number of 1 to 6, an alicyclic group having a carbon number of 3 to 6, and a substituted or unsubstituted phenyl group.

7. The toner according to claim 1, wherein a content of the vinyl resin is 10% by mass to 50% by mass of total resin components.

8. The toner according to claim 1, wherein the vinyl resin has a mass average molecular mass of from 3,000 to 50,000.

9. The toner according to claim 1, wherein the vinyl resin has a glass transition temperature of from 40° C. to 80° C.

10. The toner according to claim 1, wherein the functional group-containing modified polyester resin is a modified polyester resin having an isocyanate group at an end thereof.

11. The toner according to claim 1, wherein the toner comprises a modified polyester resin having at least one of a urethane group and a urea group.

12. The toner according to claim 1, wherein the toner comprises a charge controlling agent.

13. The toner according to claim 1, wherein the aqueous medium comprises resin fine particles.

14. The toner according to claim 1, wherein a ratio, RI=11/12, of peak absorbance around 700 cm⁻¹, I1, to peak absorbance around 730 cm⁻¹, 12, in an infrared absorption spectrum of the toner measured by FT-IR method, and a ratio, RA=A1/A2, of peak absorbance around 700 cm⁻¹, A1, to peak absorbance around 730 cm⁻¹, A2, in an infrared absorption spectrum of the toner measured by FT-ATR-IR method, satisfy: RI<RA.

15. A method for producing a toner comprising:
at least one of dissolving and dispersing at least a polyester resin, a vinyl resin, a releasing agent, and a colorant in an organic solvent,
wherein the polyester resin comprises a functional group-containing modified polyester resin capable of undergoing at least one of an elongation reaction and a crosslinking reaction with an active hydrogen group-containing compound; and then at least one of emulsifying and dispersing at least one of the dissolved solution and the dispersed solution in an aqueous medium, wherein a content of the vinyl resin is 10% by mass to 50% by mass of total resin components.

16. An image forming method comprising:
forming a latent electrostatic image on a latent electrostatic image bearing member;
developing the latent electrostatic image using a toner to form a visible image;
transferring the visible image to a recording medium; and
fixing the image transferred to the recording medium,
wherein the toner is obtained by:
at least one of dissolving and dispersing at least a polyester resin, a vinyl resin, a releasing agent, and a colorant in an organic solvent,
wherein the polyester resin comprises a functional group-containing modified polyester resin capable of undergoing at least one of an elongation reaction and a crosslinking reaction with an active hydrogen group-containing compound;
then at least one of emulsifying and dispersing at least one of the dissolved solution and the dispersed solution in an aqueous medium to prepare an emulsified dispersion; and
allowing the functional group-containing modified polyester resin to undergo at least one of an elongation reaction and a crosslinking reaction with the active hydrogen group-containing compound in the aqueous medium,
wherein the vinyl resin is concentrated near the surface of the toner.
